(19) United States
(12) Patent Application Publication
(10) Pub. No.: US 2020/0084027 A1
(43) Pub. Date: Mar. 12, 2020

(54) SYSTEMS AND METHODS FOR ENCRYPTION OF DATA ON A BLOCKCHAIN

(71) Applicants: BANK OF MONTREAL, Toronto (CA); ERSTE GROUP BANK AG, Vienna (AT); UBS SWITZERLAND AG, Zurich (CH); COMMERZBANK AG, Frankfurt Am Main (DE); CAXIABANK S.A., Barcelona (ES)

(72) Inventors: Lubomir DUCHON, Bratislava (SK); Richard HOLZEIS, Grob Enzersdorf (AT)

(21) Appl. No.: 16/563,188

(22) Filed: Sep. 6, 2019

Related U.S. Application Data
(60) Provisional application No. 62/727,693, filed on Sep. 6, 2018.

(51) Int. Cl. H04L 9/08; H04L 9/06; G06Q 20/38

(52) U.S. Cl. CPC H04L 9/0825; H04L 9/0822; G06Q 20/38215; H04L 9/0637; H04L 9/0861

(57) ABSTRACT

Methods and systems for encrypting and decrypting data on a blockchain may comprise, upon receiving a request to encrypt data elements of a first data block of a blockchain to only be accessible to a subset of nodes of the blockchain, generating an encryption key configured to encrypt the data elements of the first data block; encrypting the data elements of the first data block using the encryption key; retrieving a public key corresponding to each node within the subset of nodes; encrypting the encryption key using the public key corresponding to each node within the subset of nodes, generating an encrypted encryption key for each node within the subset of nodes; generating a second data block comprising the encrypted encryption key for each node and the encrypted data elements of the first data block; and appending the second data block to the blockchain.

### CROSS-REFERENCE TO RELATED APPLICATIONS

This application claims priority to U.S. Provisional Application No. 62/727,693, filed Sep. 6, 2018, which is hereby incorporated by reference in its entirety.

### TECHNICAL FIELD

This disclosure generally relates to the field of data structures, such as blockchains, and in particular to encryption of data on a blockchain.

### BACKGROUND

As the processing power of computers allows for greater computer functionality, and the Internet technology era allows for interconnectivity between computing systems, many institutions store sensitive data records on distributed data structures, such as blockchains. In order to prevent unauthorized access, conventional blockchain services may limit public access to the content of blockchains by requiring users to be authenticated before users are able to view and/or revise (e.g., add new data blocks) the blockchain. Conventional blockchain services may also encrypt the data stored onto blockchains, such that only an authorized user may access the encrypted data. For example, if a blockchain records a confidential transaction between two or more parties, then the transaction data may need to be encrypted so that the public (or certain nodes within the blockchain) cannot view the transaction data on the blockchain. In addition, the encrypted data needs to be decrypted by the participants involved in the transaction so only the participants may access the transaction details.

Conventional blockchain services use “one-to-one” encryption methods to encrypt the data for each authorized node (e.g., participant). Therefore, conventional blockchain services encrypt the same data elements multiple times (one encryption per participant). This encryption method replicates a method utilized by conventional database management systems. However, when implemented on blockchains (or other distributed data structures), utilizing conventional encryption methods may produce latency in the process of building the blockchain, which is highly undesirable.

### SUMMARY

For the aforementioned reasons, there is a need to encrypt data in an efficient manner without encrypting the same data multiple times and without producing unnecessary latency. There is a need for an encryption method that utilizes symmetrical and asymmetrical encryption methods to efficiently generate new data blocks that can be accessed by all nodes but decrypted by a selected group of nodes only.

In an embodiment, a computer system comprises a data structure distributed among a set of nodes, the data structure having a plurality of data blocks, each block comprising data elements accessible to at least one node within the set of nodes; a processor in communication with at least one node, wherein when the processor receives a request to encrypt data elements of a first data block within the plurality of data blocks to only be accessible to a subset of nodes within the set of nodes, the processor is configured to: generate an encryption key, wherein the encryption key is configured to encrypt the data elements of the first data block; encrypt the data elements of the first data block using the encryption key; retrieve a public key corresponding to each node within the subset of nodes; encrypt the encryption key using the public key corresponding to each node within the subset of nodes, wherein the processor generates an encrypted encryption key for each node within the subset of nodes; generate a second data block comprising the encrypted encryption key for each node within the subset of nodes and the encrypted data elements of the first data block; and append the second data block to the plurality of data blocks.

In another embodiment, a method comprises upon receiving a request to encrypt data elements of a first data block of a plurality of data blocks to only be accessible to a subset of nodes within a set of nodes associated with a blockchain generating, by a processor of at least one node, an encryption key, wherein the encryption key is configured to encrypt the data elements of the first data block; encrypting, by the processor, the data elements of the first data block using the encryption key; retrieving, by the processor, a public key corresponding to each node within the subset of nodes; encrypting, by the processor, the encryption key using the public key corresponding to each node within the subset of nodes, wherein the processor generates to generate an encrypted encryption key for each node within the subset of nodes; generating, by the processor, a second data block comprising the encrypted encryption key for each node within the subset of nodes and the encrypted data elements of the first data block; and appending, by the processor, the second data block to the plurality of data blocks.

In another embodiment, a data structure is distributed among a set of nodes, the data structure comprises a plurality of data blocks, each block comprising data elements hosted on and accessible to at least one node within the set of nodes, wherein a processor in communication with at least one node is configured to in response to receiving a request to encrypt data elements of a first data block within the plurality of data blocks to only be accessible to a subset of nodes within the set of nodes, generate an encryption key, wherein the encryption key is configured to encrypt the data elements of the first data block; encrypt the data elements of the first data block using the encryption key; retrieve a public key corresponding to each node within the subset of nodes; encrypt the encryption key using the public key corresponding to each node within the subset of nodes, wherein the processor generates to generate an encrypted encryption key for each node within the subset of nodes; generate a second data block comprising the encrypted encryption key for each node within the subset of nodes and the encrypted data elements of the first data block; and append the second data block to the plurality of data blocks.

In accordance with an aspect, there is provided a hybrid encryption process for blocks of data on a blockchain or data storage ledger. In accordance with an aspect, there is provided a system for encrypting data. The system has a distributed data structure of a plurality of nodes, each node including at least a computing device, and the distributed data structure having a plurality of blocks, each block comprising one or more data elements. The system has a processor having an encryption application configured to: generate a secret key; encrypt the generated secret key with a public key to obtain an encrypted secret key; encrypt a data element with the generated secret key to obtain an encrypted data element; compose a block for an encrypted asset having the encrypted secret key and the encrypted data element; and update the distributed data structure with the composed block.

In some embodiments, the processor with the encryption application is configured to encrypt the generated secret key with a first public key to obtain a first encrypted secret key, encrypt the generated secret key with a second public key to obtain a second encrypted secret key, and compose the block with the encrypted asset having the first encrypted secret key and the second encrypted secret key.

In some embodiments, the data element corresponds to a transaction, wherein the processor with the encryption application is configured to, prior to updating the distributed data structure, identify participants to the transaction, and receive consensus results from the participants in the transaction. In some embodiments, the processor with the encryption application is configured to provide a nonce as an input parameter to each of the participants for generating the output results. In some embodiments, the processor with the encryption application is configured to generate the secret key using a nonce received as an input parameter.

In some embodiments, the processor with the encryption application is configured to compose the block having a map that links an organization identifier to the encrypted secret key. In accordance with an aspect, there is provided a computer-implemented method for encrypting data on a blockchain. The method involves generating, by a computer processor, a secret key; encrypting the generated secret key with a public key to obtain an encrypted secret key; encrypting a data element with the generated secret key to obtain an encrypted data element; composing a block including the encrypted secret key and the encrypted data element; and updating the blockchain with the composed block. In some embodiments, the method encrypts the generated secret key with a first public key to obtain a first encrypted secret key, encrypts the generated secret key with a second public key to obtain a second encrypted secret key, and composes the block with the encrypted asset having the first encrypted secret key and the second encrypted secret key.

In accordance with an aspect, there is provided a system for decrypting data on a blockchain. The system has a non-transitory computer-readable memory device storing a private key; a computer processor configured to: access a distributed blockchain of a plurality of nodes, each node including at least a computing device, and the distributed blockchain having a plurality of blocks; identify a block with an encrypted data asset, the encrypted data asset having an encrypted secret key that is encrypted using a public key corresponding to a private key for an organization associated with an organization identifier, the encrypted data asset having a map linking the organization identifier to the encrypted secret key, the encrypted data asset having an encrypted payload that is encrypted using the secret key; decrypt the encrypted key using the private key to obtain the key; and decrypt the encrypted payload using the secret key to obtain a data element.

In accordance with an aspect, there is provided a computer-implemented method for decrypting data on a blockchain. The method involves accessing a distributed blockchain of a plurality of nodes, each node including at least a computing device, and the distributed blockchain having a plurality of blocks, each block comprising at least a data element; identifying a block with an encrypted data asset, the encrypted data asset having an encrypted secret key that is encrypted using a public key corresponding to a private key for an organization associated with an organization identifier, the encrypted data asset having a map linking the organization identifier to the encrypted secret key, the encrypted data asset having an encrypted payload that is encrypted using the secret key; decrypting the encrypted key using the private key to obtain a secret key; and decrypting the encrypted payload using the secret key to obtain a data element.

In some embodiments, the data element corresponds to a transaction. In some embodiments, there is consensus or verification of a transaction achieved by the N participants of the transaction (e.g. buyer(s) and seller(s)). In some embodiments, the system or method involves the use of a consistent/deterministic token (considering randomness of encryption process) by extracted entropy as input for the transaction/encryption. In some embodiments, the system or method involves storage of both transaction data and business logic on the blockchain or ledger (for both writing and accessing stored data). In some embodiments, the system or method involves multi-tenancy so that peer/node can service multiple participants with access to the participant's key. In some embodiments, the system or method involves a generated encrypted secret key that may include an array of N elements of data corresponding to different encrypted symmetric secret keys for various participants, and a payload that includes a map with the encrypted symmetric secret key.

### BRIEF DESCRIPTION OF THE DRAWINGS

Embodiments will now be described, by way of example only, with reference to the attached figures, wherein in the figures:

FIG. 1 illustrates a block diagram illustrating a blockchain topology, in accordance with an embodiment.

FIG. 2 illustrates a blockchain, in accordance with an embodiment.

FIG. 3 illustrates a schematic diagram of an encryption platform, according to an embodiment.

FIG. 4 illustrates a schematic diagram of a symmetric encryption and decryption, in accordance with an embodiment.

FIG. 5 illustrates a schematic diagram of a key pair generation, in accordance with an embodiment.

FIG. 6 illustrates a schematic diagram of an asymmetric encryption and decryption, in accordance with an embodiment.

FIG. 7 illustrates a data encryption framework, in accordance with an embodiment.

FIG. 8 illustrates a data decryption framework, in accordance with an embodiment.

FIG. 9 illustrates a flow chart of an example data encryption and decryption process, in accordance with an embodiment.

FIGS. 10 and 11 illustrate various examples of data encryption, according to some embodiments.

FIG. 12 illustrates a block of a blockchain containing encrypted data elements, in accordance with an embodiment.

FIG. 13 illustrates a schematic diagram of an encryption platform with a smart contract, in accordance with an embodiment.

FIG. 14 illustrates a schematic diagram of an encrypted asset interface, in accordance with an embodiment.

FIG. 15 illustrates an encrypted asset, in accordance with an embodiment.

FIG. 16 illustrates a schematic diagram of a platform with a blockchain client and smart contracts, in accordance with an embodiment.

FIG. 17 illustrates a schematic diagram of an arrangement of hosts and peers, in accordance with an embodiment.

FIG. 18 illustrates a schematic diagram of a method for encrypting and decrypting blockchain data, according to an embodiment.

FIGS. 19A-B illustrate visual presentations of the encryption and decryption methods described herein, according to an embodiment.

### DETAILED DESCRIPTION

It will be appreciated that numerous specific details are set forth in order to provide a thorough understanding of the exemplary embodiments described herein. However, it will be understood by those of ordinary skill in the art that the embodiments described herein may be practiced without these specific details. In other instances, well-known methods, procedures and components have not been described in detail so as not to obscure the embodiments described herein. Furthermore, this description is not to be considered as limiting the scope of the embodiments described herein in any way, but rather as merely describing implementation of the various example embodiments described herein.

Methods and systems to overcome the technical shortcomings described above are described herein using various figures depicting various non-limiting examples of system architectures, flow charts, and visual illustrations of encryption keys and blockchains to describe how a processor can encrypt and decrypt data within a blockchain. As will be described below, a processor may encrypt and decrypt blockchain data (e.g., data elements) by first generating a unique encryption key and symmetrically encrypting data elements using the unique encryption key. The processor may then asymmetrically encrypt the content of the encryption key using public keys for one or more authorized nodes. The processor may then place the encrypted encryption key and the encrypted data elements within a block and append the block to the blockchain.

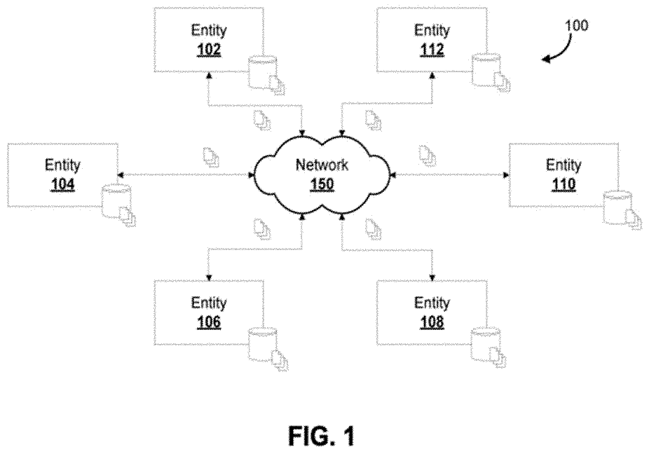

Encryption and decryption methods described herein can be implemented on one or more processors associated with a distributed data structure, such as a blockchain. FIG. 1 illustrates a non-limiting example of a system architecture that could support encryption and decryption of data in accordance with the methods described herein. Accordingly, FIG. 1 is a block diagram illustrating a blockchain topology 100 that provides a blockchain of blocks distributed across one or more entities 102, 104, 106, 108, 110, and 112, over a network 150, according to some embodiments. A blockchain is an example data storage ledger with entries that can be stored on blocks and accessed from blocks. Each block may store one or more data elements. The one or more data elements may represent a message, a transaction, a digital address of a digital currency unit, an audio, a video, or any other type of information. Entities 102, 104, 106, 108, 110, and 112 may include, for example, parties to a transaction, individual computing devices, shared computing resources, smart devices (e.g., smart watches), and so on. The entities may store the blockchain on computing systems, which may be utilized in maintaining and/or updating the blockchain. Each entity 102, 104, 106, 108, 110, and 112 may be configured for storing a version of the blockchain, and the blockchain may be updated from time to time with modifications or updates to the blockchain, such as insertion of a new block. The blockchain topology 100 may be adapted such that where issues arise with the blockchain (e.g., hash collisions, insertions of a block at the same time, corrupted entries), the issues can be automatically resolved based on some pre-determined logic. For example, such logic may be distributed among each of the entities 102, 104, 106, 108, 110, and 112 and/or their computing systems. In some embodiments, issues may arise that can cause a blockchain to “fork” and/or spawn another instance, for example, where a collision cannot be automatically resolved.

In some embodiments, a blockchain may be considered as a public or private ledger that contains all existing transactions between two or more transacting parties. It may be viewed as a permanent record of all transactions that have occurred between the parties. A blockchain may be expanded or updated by adding a secure transaction record, in the form of an encrypted block, by one or more servers or nodes. Each entity 102, 104, 106, 108, 110, and 112 may act as a node of a blockchain. In some embodiments, the blockchain may only be updated through consensus of a majority of nodes in the system. Once entered and encrypted, the transaction information in a block of a blockchain cannot be modified or erased. Details of a transaction, including parties, assets, transaction time, signatures, consideration, costs, and other terms, may be captured by one or more data elements within a block. The blocks may be encrypted to ensure transaction details stay confidential.

In some embodiments, a transaction may involve two or more parties. For example, a transaction may involve five or more parties or participants, such that the data elements representing the transaction data may need to be encrypted and transmitted to a great number of participants.

One or more data elements within a block may be encrypted by an encryption algorithm or process, for example, using a cryptographic hash function. Such a cryptographic hash function may be known as a one-way hash function, that is, it may be, mathematically speaking, nearly impossible to invert. Input data to the encryption process may be known as “plain text”, “clear text”, “input” or “message”, whereas the output of the encryption process may be known as “cipher text”, “cypher text”, “output”, “hash digest”, “digest”, or “hash value”. An encryption may use an appropriate hash function. In some embodiments, the cryptographic hash function may be one of MD5, SHA1, and SHA2, for example.

In some embodiments, “plain text” or “clear text” refers to unencrypted information or data that is transmitted or stored unencrypted. This may be the text or data a human user can read and understand the content thereof, for example, “hello world”. “Cipher text” or “Cypher text” may refer to the result of encryption performed on plain text using an encryption algorithm, which may be referred to as a cipher. A cipher text or cypher text therefore is the text or data a human user can read but not understand, for example, “010573c2e07d0”. That is, the cipher text needs to be decrypted first to be used for its purpose.

“Encryption” refers to a process of encoding plain text into a form of cipher text, which only authorized parties can decrypt. A party may be an authorized party if it possesses a key that is necessary for decrypting the cipher text back into the plain text.

The “cryptographic key” or simply “key” is a piece of information (e.g., a parameter) that determines the functional output of a cryptographic (or encryption) algorithm. Generally, using different keys for the same plain text and the same encryption algorithm would each produce a different cipher text. That is, even if an unauthorized party knows the encryption (or indeed, decryption) algorithm, it cannot decrypt the cipher text into the original plain text without the key.

In some embodiments, the entities 102, 104, 106, 108, 110, and 112 include at least one or more computing devices, which may include personal or business computing devices. The computing devices may be decentralized.

The blockchain may be maintained through, for example, a “distributed network system”, the distributed system providing decentralized control and storage of the blockchain at the one or more entities (which may be considered “nodes” of the system). The number of “nodes” may be fixed or vary with time, and increasing or decreasing the number of “nodes” may affect the performance and/or security of the system. The data elements stored and maintained at each “node” may provide cross-validation with one another in the event of conflicts between blocks, and various cryptographic and/or hashing algorithms may be utilized during the generation, updating, deletion, linking, etc., of block entries such that block entries have increased resiliency to unauthorized tampering or modification.

For example, a blockchain may be distributed across entities 102, 104, 106, 108, 110, and 112 and used to track information relating to various transactions, terms, conditions, documents, and so on. The blockchain may have entries linked to one another using cryptographic records, and entries in the blockchain may be ordered, time stamped, and/or associated with metadata such that the blockchain is designed for protection against “double” transfers and unauthorized modification of data elements in any block.

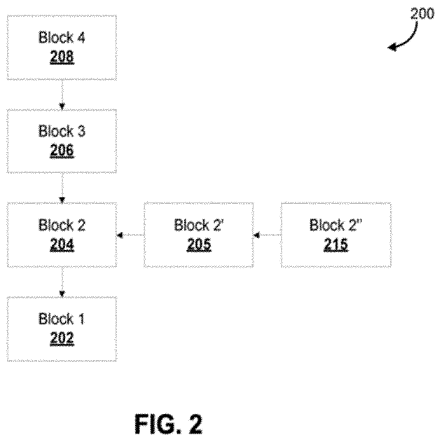

Encryption and decryption methods described herein can be implemented on any distributed data structure, such as a blockchain. To better illustrate distributed data structures, FIG. 2 visually depicts an illustrative blockchain having multiple data blocks, according to an embodiment. Block 1 202, block 2 204, block 3 206, and block 4 208 illustrate example blocks that provide a blockchain 200. Each block 202, 204, 206, 208 may include one or more data elements. Block 2′ 205 and block 2″ 215 are orphan or extinct blocks that may have been initially accepted by the majority of the distributed network, but are later rejected when proof of a longer blockchain is received that does not include the blocks. The data elements in an orphan block 205, 215 may be valid data entries but are not considered a valid part of the blockchain.

In some embodiments, a block may include one or more data elements, each representing a party to the same transaction, or an intended recipient for a message. For example, a data element may include a company name, an individual name, a user ID, an e-mail address, a phone number or an identification number. The block also can include a timestamp indicating when the block was created. If there is more than one block in the blockchain 200, each block beyond a first block further may include a data element representing an encrypted form (e.g., a hash) of a previous block in the blockchain.

Blocks may be created, as an block originating (i.e., genesis block) or a block linked to a previous block, and upon creation, the block may require insertion into the blockchain by the distributed network if it is not the genesis block. If it is the first block, a new blockchain may be established.

In some implementations, the amount of time for insertion and/or validation may be significant. It may take several minutes or longer for a block to be created and validated for insertion into the blockchain by the distributed network. The transaction may not complete until the block is successfully created and inserted in the chain. In accordance with some embodiments, the blockchain and/or blocks themselves may be configured to reduce the amount of time needed for validation and/or insertion, as such time may lead to vulnerabilities in the integrity of the blockchain. For example, as described herein, various encryption techniques may be implemented to reduce the time required for encrypting and creating a block.

Blocks in the blockchain may be stored and shared across computers in the distributed network, such that each computer, or node, in the network maintains an updated storage of all existing blocks. In some embodiments, the entire blockchain may be accessible to each node in the distributed network via the last block, and a node may be able to trace back the history and original creation of one or more data elements by looking at one block and retrieving previous blocks in the chain starting from the reference contained in the last block. Accordingly, it may be difficult to tamper with a block embedded in the blockchain as modifications may be readily detected or identified by computing a hash based on data elements in the following data blocks: if the computed hashes do not match, then the block may have been tampered with.

Each block in a blockchain may include, for example, one or more data elements representing a transaction, a message, a user ID, a cryptocurrency balance and so on. The data elements can also include a timestamp indicating the time of the transaction; a hash of the immediately preceding block representing the same cryptocurrency; and a hash of the current block. Other types of data may also be included, depending on the particular blockchain implementation.

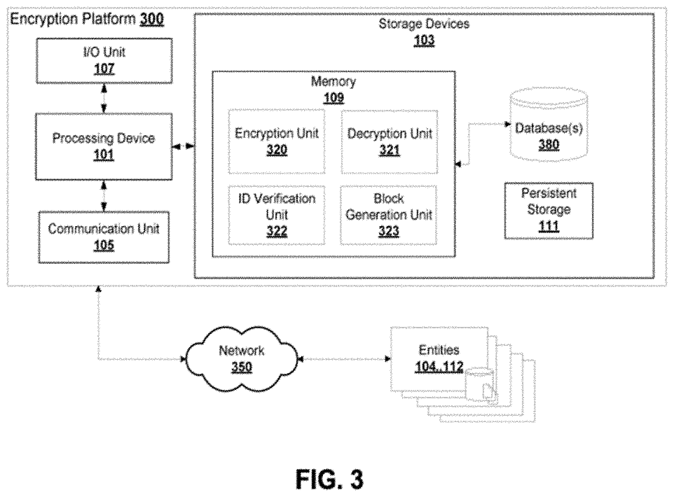

Encryption and decryption methods described herein can be implemented on various computer platforms having different modules. In some embodiments, a computer platform can be reconfigured to encrypt/decrypt data as described herein. Accordingly, FIG. 3 is a schematic diagram of an example encryption platform, according to an embodiment. Entities 102, 104, 106, 108, 110, and 112 may each have a platform 300 to encrypt, decrypt, compose a block and update a block with the composed block chain using encryption unit 320, decryption unit 321, ID verification unit 322, and block generation unit 323.

In some embodiments, platform 300 may be implemented on a computing device acting as a node, or part of a node, within a distributed network for a blockchain. In other embodiments, platform 300 may be implemented on a computing device that does not form part of a node within the distributed network, but simply has access to blockchain through network 350.

A processing device 101 can execute instructions in memory 109 to configure encryption unit 320, decryption unit 321, ID verification unit 322, and block generation unit 323. A processing device 101 can be, for example, any type of general-purpose microprocessor or microcontroller, a digital signal processing (DSP) processor, an integrated circuit, a field programmable gate array (FPGA), a reconfigurable processor, or any combination thereof.

Memory 109 may include a suitable combination of any type of computer memory that is located either internally or externally such as, for example, random-access memory (RAM), read-only memory (ROM), compact disc read-only memory (CDROM), electro-optical memory, magneto-optical memory, erasable programmable read-only memory (EPROM), and electrically erasable programmable read-only memory (EEPROM), Ferroelectric RAM (FRAM) or the like. The storage 103 includes memory 109, databases 380, and persistent storage 111.

The persistent storage 111 may be configured to store information associated with the blockchain, such as the blockchain, blocks, data elements, other information stored on various blocks, linkages between blocks, rules associated with the blockchain, and so on. Storage 103 and/or persistent storage 111 may be provided using various types of storage technologies, such as solid state drives, hard disk drives, or flash memory, and may be stored in various formats, such as relational databases, non-relational databases, flat files, spreadsheets, extended markup files, etc.

Each I/O unit 107 enables the platform 300 to interconnect with one or more input devices, such as a keyboard, mouse, camera, touch screen and a microphone, or with one or more output devices such as a display screen and a speaker.

Each communication interface 105 enables the platform 300 to communicate with other components, to exchange data with other components, to access and connect to network resources, to serve applications, and to perform other computing applications by connecting to a network (or multiple networks) capable of carrying data including the Internet, Ethernet, plain old telephone service (POTS) line, public switch telephone network (PSTN), integrated services digital network (ISDN), digital subscriber line (DSL), coaxial cable, fiber optics, satellite, mobile, wireless (e.g. Wi-Fi, WiMAX), SS7 signaling network, fixed line, local area network, wide area network, and others, including any combination of these.

The platform 300 is operable to register and authenticate users (using a login, unique identifier, and password, for example) prior to providing access to applications, a local network, network resources, other networks and network security devices. The platform 300 may serve one user or multiple users.

The platform 300 generates encrypted data elements that form at least part of a block and update a blockchain with the block. The platform 300 may be implemented in part as an encryption application that may be programmed with instructions and stored on the memory 109. The platform 300 can include persistent storage 111 that maintains a distributed blockchain of a plurality of nodes, or interacts with a set of entities 102, 104, 106, 108, 110, and 112 that maintain the distributed blockchain. Each block in a blockchain includes one or more encrypted data elements that may be decrypted by the platform 300.

In some embodiments, the decryption process of one or more data elements in a block of a blockchain may be performed by a client device that does not have the platform 300 implemented therein. For example, decryption unit 321 may be separately programmed and implemented, apart from the platform 300. The client device may or may not be part of a node within the distributed network.

ID verification unit 322 can be configured to verify the identity of a user prior to allowing the user access to confidential information stored in one or more data elements in a block of the blockchain. For example, access may be granted if the user ID corresponds to a party or participant in a transaction with its details stored within the block. For another example, access may be allowed if the user ID is associated with a set of privileges and user rights granting the user ID read and/or write privileges to the block.

Encryption unit 320 may be configured to encrypt one or more data elements into encrypted content based on an encryption technique or algorithm. In some embodiments, encryption unit 320 determines, retrieves or generates an appropriate key to encrypt one or more data elements in order to generate encrypted data elements. Each key used for encryption may be stored in database 380.

In some embodiments, once encrypted, the data elements may be transmitted to one or more entities or recipients. The transmitting of cipher text (e.g., encrypted data elements) may be carried by an unsecured channel, such as HTTP, e-mail, voice, radio, books, notes, and so on, or by a secured transmission channel such as HTTPS.

Decryption unit 321 may be configured to decrypt one or more encrypted data elements into plain text based on an encryption technique or algorithm, along with a key. In some embodiments, decryption unit 321 determines, retrieves or generates an appropriate key to decrypt one or more encrypted data elements in order to generate the plain text.

Block generation unit 323 may be configured to create or compose a new block including at least encrypted data elements generated by encryption unit 320. The new block may also include plain text data, such as plain text data decrypted by decryption unit 321 from one or more existing blocks of the blockchain. Once a new block is properly created, it may be appended by platform 300 to the blockchain, such that any intended receipt of one or more encrypted data elements within the new block may be properly notified and can decrypt the data elements accordingly.

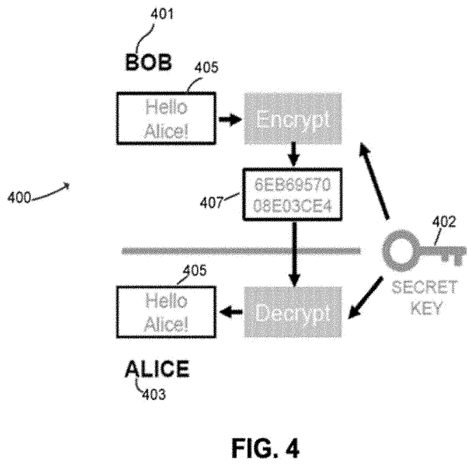

In symmetrical encryption/decryption, the same encryption key may be utilized to encrypt and decrypt data. In order to better illustrate how an encryption key can be applied to data elements, FIG. 4 visually depicts how a “secret key” is utilized by a processor to encrypt/decrypt data. Accordingly, FIG. 4 is a schematic diagram of an example symmetric encryption and decryption process 400, which may be implemented by encryption unit 320 and decryption unit 321. In a symmetric encryption method, the same secret key 402 is used for encryption and decryption. For example, as illustrated, a user 401 (e.g., Bob) may wish to send a message “Hello Alice!” 405 to another user 403 (e.g., Alice). Bob does not want anyone else but Alice to see the message, so he encrypts the plain message 405 with a secret key 402 and obtains as a result an encrypted message 407. Encrypted message 407 is transmitted to Alice, who then can use the same secret key 402 to decrypt the encrypted message 407 to obtain original plain text “Hello Alice!” 405. This symmetric encryption method provides a fast encryption algorithm that can encrypt data of any length. However, the secret key 402 used for the encryption needs to be kept as a secret and exchanged only between the parties using a secure channel, e.g. through personal delivery on USB stick. In addition, as this encryption method requires Bob to have a copy of Alice's secret key, or vice versa, it may not be ideal for a situation when a user wishes to send an encrypted data element (e.g., a cryptocurrency unit) to a stranger.

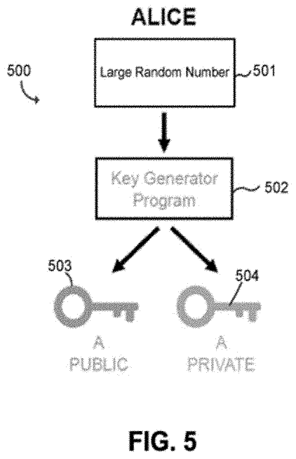

In order to encrypt data (whether symmetrical or asymmetrical), a processor may first generate an encryption key. FIG. 5 is a schematic diagram of an example cryptography key pair generation process 500, which may be used in asymmetric encryption method. The encryption unit 320 may generate such a key pair through a key generator program 502. Alternatively, encryption unit 320 may have access to at least one key in the key pair through database 380. A key pair may be generated with a large random number 501 generated by a random number generator (RNG) or pseudorandom number generator (PRNG), which is then put through a key generator program 502, to generate a public key 503 and a corresponding private key 504. The public key 503 may be shared and distributed to everyone. The private key 504 is kept secret by the owner. There may be no feasible method to compute the private key from the corresponding public key.

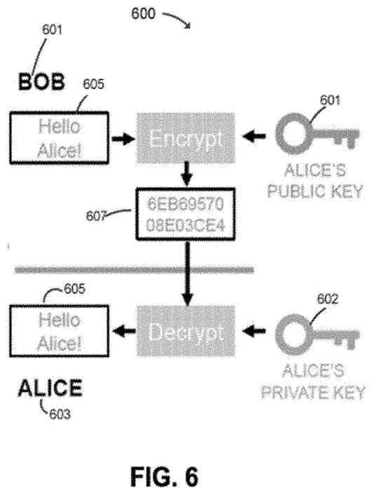

In asymmetrical encryption/decryption, different keys may be utilized to encrypt and decrypt data. For instance, a key can be applied to encrypt data elements and another key can be applied to decrypt the same data elements. FIG. 6 is a schematic diagram of an example asymmetric encryption and decryption process 600, which may be implemented by encryption unit 320 and decryption unit 321. A first user 601 (e.g., Bob) encrypts a plain text message 605 using a second user 603's public key 601 (also known as “encryption key”), which has a corresponding private key 602. The encrypted message 607 appears to be a random string, e.g., “6EB6957008E03CE4” and is transmitted over a network to the intended recipient, i.e., the second user 603. The second user uses her private key 602 (also known as “decryption key”) to decrypt the encrypted message 607 to retrieve the original plain text message 605. This encryption method does not require a secure channel for the key exchange, since the second user's public key is public and accessible from all nodes on the blockchain. For example, the public key corresponding to the first user 601 may be already stored in database 380 connected to encryption unit 320. Security of this encryption method depends on the secrecy of the private key, which is kept confidential by the second user at all times. On the other hand, this asymmetric encryption method has slower algorithms compared to symmetric encryption and can be restrictive in terms of an acceptable length of data element (e.g., plain text 605) that can be encrypted using the method.

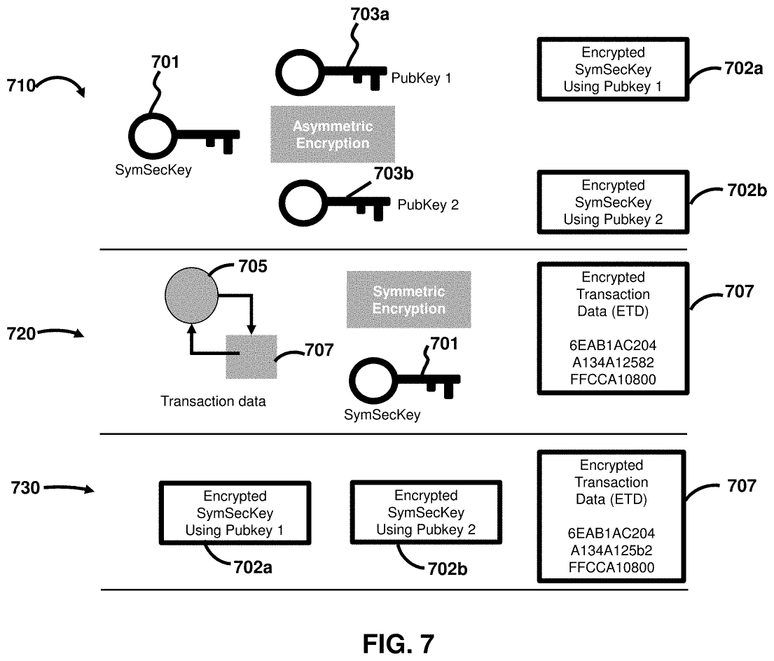

In some embodiments, a processor may utilize both symmetrical and asymmetrical encryption methods to encrypt data elements. FIG. 7 illustrates an example data encryption framework, which may be implemented by encryption unit 320. While this encryption framework can be used to encrypt data elements meant for a single recipient, it is particularly suitable for encrypting the same data elements for transmission to multiple recipients. In some embodiments, there is a respective public-private key pair for every recipient of a plurality of recipients, and each public-private key pair is different from the rest of key pairs. For each public-private key pair, the public key 703a, 703b is shared among all recipients and all parties who may be sending encrypted data elements to one of the recipients. In some embodiments, the public keys may be shared among all nodes in a blockchain. At each node, the public keys may be stored at a local memory device of a computing device, such as database 380. Each private key 708 is kept private by the respective recipient. In a blockchain setting, each recipient may be a receiver and a sender of encrypted data elements 707.

Every time an entity or node, acting for a party or participant of a transaction, needs to update the blockchain 200 with a new block containing one or more data elements representing the transaction details, the one or more data elements within the new block need to be encrypted first to ensure privacy. At step 710, each time the data elements of a block need to be encrypted, a new symmetric secret key 701 can be generated. The symmetric secret key 701 can be encrypted, for each intended recipient (e.g. a party to the transaction), using a respective public key 703a, 703b to generate a respective encrypted secret key 702a, 702b. That is, each respective encrypted secret key 702a, 702b corresponds to a respective private key associated with a respective public key 703a, 703b used to generate the respective encrypted secret key 702a, 702b. Therefore, the symmetric secret key 701 can only be extracted from encrypted secret key 702a, 702b by an authorized recipient using its respective private key.

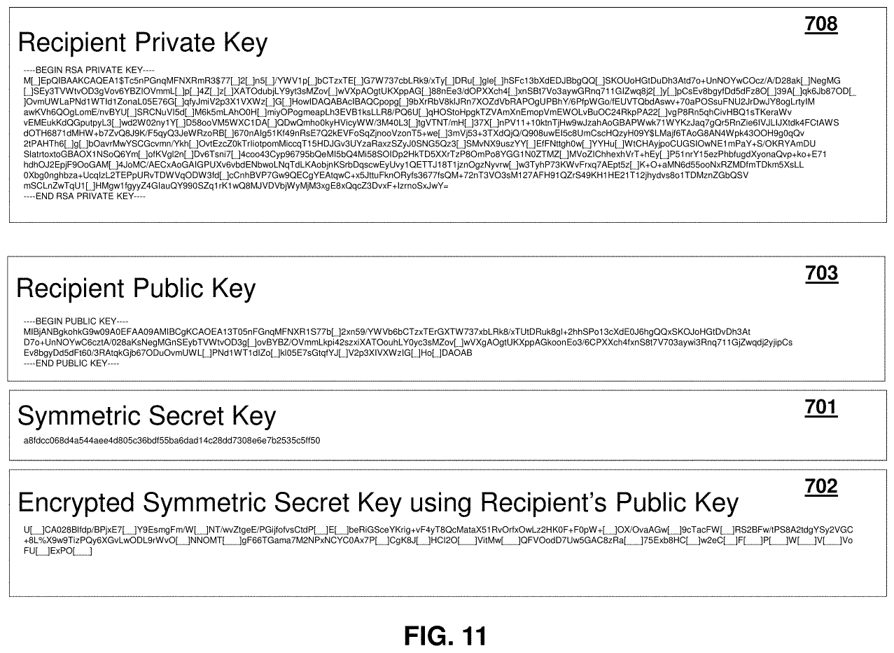

In some embodiments, the generated encrypted secret key 702 may include arrays of N elements of data of encrypted symmetric secret key, see for example FIG. 11. The contents of the transaction is encrypted as the payload of the encrypted asset. The encrypted asset also includes encrypted symmetric secret keys for different organizations or participants.

At step 720, one or more data elements 705 may be encrypted with the symmetric secret key 701 to generate encrypted data elements 707 (e.g. encrypted transaction data). In some embodiments, the one or more data elements 705 may be in plain text.

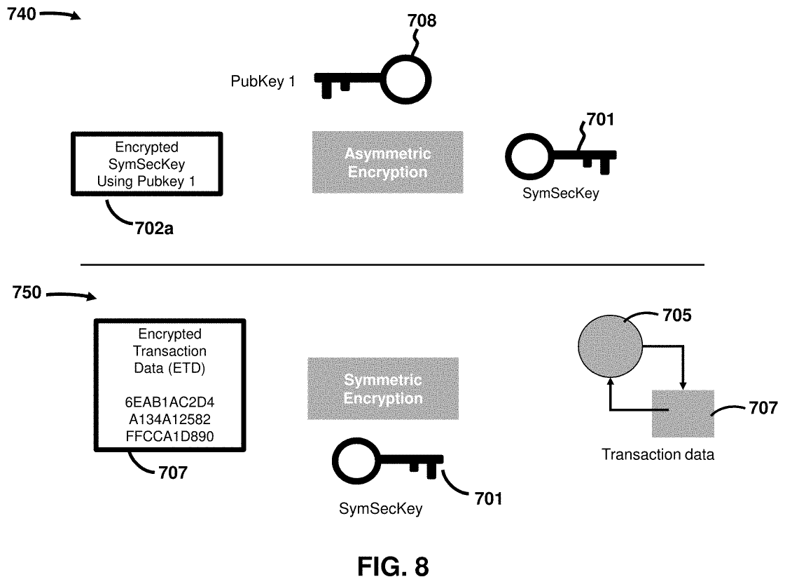

At step 730, block generation unit 323 may create a new block including: each encrypted secret key 702a, 702b and the encrypted data elements 707. Block generation unit 323 may then append this new block to blockchain 200. The new block may have a plurality of encrypted secret keys 702a, 702b, each of the encrypted secret keys being intended for a specific recipient or participant. All of the intended recipients are each able to decrypt their respective encrypted secret keys 702a, 702b with their own respective private key as shown in FIG. 8. Once decrypted, the symmetric secret key 701 is the same across all recipients, and may be used to decrypt the encrypted data elements 707.

In some embodiments, a processor may utilize both symmetrical and asymmetrical encryption methods to decrypt data elements. FIG. 8 illustrates an example data decryption framework according to some embodiments, which may be implemented by decryption unit 321. A step 740, an intended recipient's computing device, which may be part of a node for blockchain 200 (e.g. platform 300 or a different system), first identifies a block of data (e.g., an encrypted secret key 702a) encrypted using the recipient's public key 703a, and subsequently decrypts the encrypted data (represented as the encrypted secret key 702a) to obtain a symmetric secret key 701 with the private key 708 corresponding to the recipient's public key 703a.

At step 750, the intended recipient's computing device identifies a block of data elements 707 encrypted using the symmetric secret key 701, and proceeds to decrypt the encrypted data elements 707 to obtain the data element 705 (e.g., plain text message). A recipient can be notified when a new block is added that is relevant to them to trigger the identification step using an event framework, for example. A custom event can be generated using the blockchain architecture and business logic. The custom event can be linked to a participant identifier. Those subscriber/listeners for the participant identifier receive an event notification that there is an update related to the participant identifier.

A world state represents the current values of all ledger states. A world state provides an index of the relevant assets or transactions to a recipient. A world state contains a link in the blockchain to where it is stored. A program might need to know the current value of a ledger state and which can be available using the world state. The program does not need to traverse the entire blockchain to calculate the current value of any ledger state, and instead the program can get it directly from the world state. Ledger state is used to record application information to be shared via the blockchain. Using the neighboring protocol each neighbor is aware of updates. Physically, the world state can be implemented as a database.

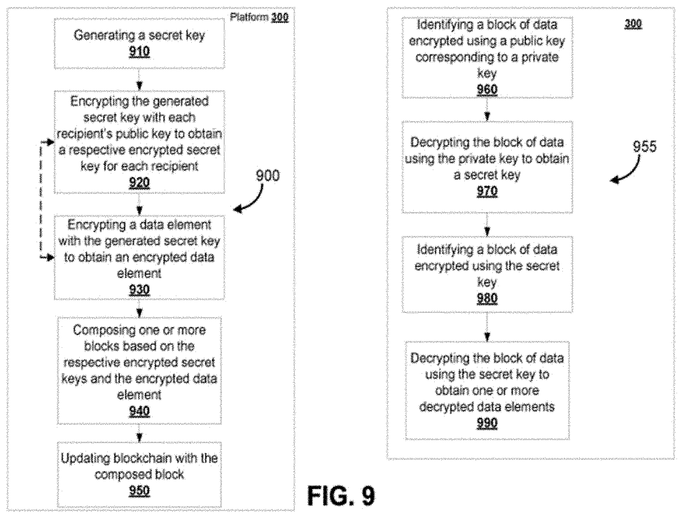

FIG. 9 is a flow chart of a non-limiting example of data encryption process 900 and a flow chart of a non-limiting example of data decryption process 955, according to some embodiments. Data encryption process 900 may be stored as computer-readable instructions in a memory device on platform 300, and executed by a processor of platform 300. At step 910, the processor receives a request for generating a secret key, which may be a symmetric secret key 701. At step 920, the processor encrypts the generated secret key 701, for each intended recipient, with the intended recipient's public key 703a, 703b to obtain a respective encrypted secret key 702a, 702b for the intended recipient. At step 930, the processor encrypts one or more data elements 705 with the generated secret key 701 to obtain encrypted data element(s) 707. At step 940, the processor creates or composes a new block including all the encrypted secret keys 702a, 703b and the encrypted data element 707. At step 950, the processor updates the blockchain with the composed block by appending the composed block to the end of the blockchain. An event notification may be automatically sent to all intended recipients (e.g., subscribers), notifying them that a message or transaction may be ready for retrieval and decryption on the blockchain.

In some embodiments, the order of steps 920 and 930 may be swapped. In some embodiments, prior to step 910 or as part of step 910, the processor determines the need to generate a new secret key 701 each time a new block of data needs to be generated. For example, every time the platform 300 receives a request to include a recently executed transaction into blockchain 200, it determines one or more data elements 705 that need to be included in a new block; such data elements 705 may include, for example, timestamp of the transaction, parties to the transaction, information regarding the parties to the transaction, authorized participants or users with access right of the transaction, details of the transaction including consideration, costs, terms and conditions, and any other information that may be required for generating a new block of the blockchain. In some embodiments, the data elements 705 may be part of a smart contract. Once platform 300 has prepared the data elements 705, it may decide, based on a pre-determined logic, to encrypt one or more of the data elements 705 before including the data elements in a new block. Once platform 300 decides to encrypt any of data elements 705, encryption unit 320 can generate a new secret key 701 for the data elements that will be included in the new block and encrypts the data elements in accordance with an encryption process described herein. Platform 300 generates the secret key off-chain. The secret key is part of the transactional input data.

Data decryption process 955, according to some embodiments, may be stored as computer-readable instructions in a memory device on platform 300, and executed by a processor of platform 300. In some embodiments, data decryption process 955 may be stored and executed by a client device or system associated with an intended recipient. The client device may not be part of platform 300, or indeed, may not be part of the blockchain. The client device may simply receive a notification (e.g., custom event via blockchain architecture and business logic and those subscriber/listeners for the ID receive the event notification that there is an update related to the ID) that a block containing a message intended for the recipient is available, at which point the device may automatically retrieve and decrypt the encrypted data block in accordance with a decryption process, such as process 955. A processor of a computing device (e.g., the client device or system) may execute steps 960 to 990. The processor may access the distributed blockchain hosted and/or supported by a plurality of nodes, each node including at least a computing device, and the distributed blockchain having a plurality of blocks, each block comprising at least a data element, which may or may not be encrypted.

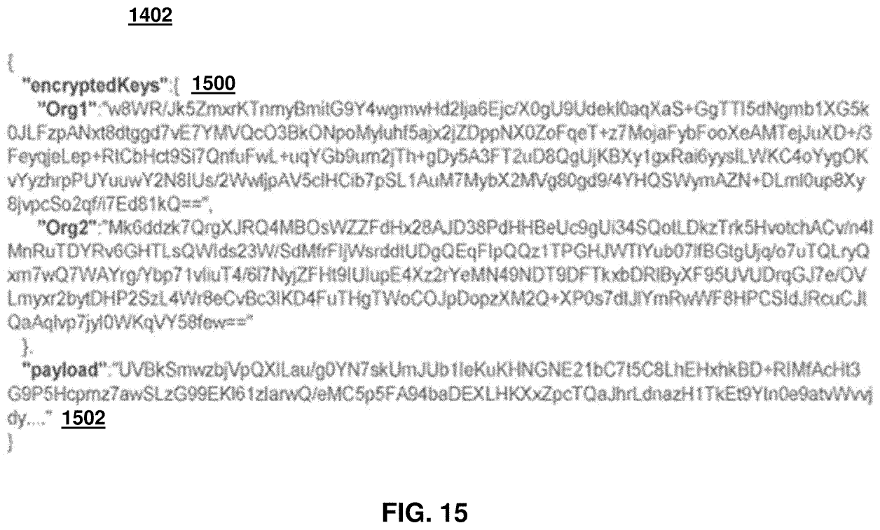

At step 960, the processor uses a map to identify an encrypted symmetric secret key 702a that is encrypted using a public key 703a corresponding to a private key 708 that belongs to the intended recipient (or organization) associated with the computing device. The processor may identify the public key 703a as belonging to the intended recipient based on the map stored as part of the block or encrypted data asset that is stored on the ledger or the blockchain. The map lists organization identifiers (Org IDs) and corresponding encrypted keys. The map lists an Org ID belonging to the intended recipient to indicate that they can decrypt the key. See, for example, FIG. 15 which has a map that indicates “Org1” (an example Org ID) linked to an encrypted key of the encrypted keys 1500. The processor uses the map to see if the Org ID is in the map, which indicates that the block is relevant to the recipient (or organization), and then the processor can proceed to implement the decryption. There is no brute force to try to decrypt and if it fails then the processor does not have access. Instead, the processor might only try to decrypt data that it knows it can actually decrypt according to the map.

At step 970, the processor decrypts the block of data (represented as the encrypted secret key 702a) using the private key 708 to obtain a secret key 701. At step 980, the processor identifies a second block of data 707 encrypted using the decrypted secret key 701, and at step 990, the processor decrypts the block of data 707 using the secret key 701 to obtain a data element 705 for the intended recipient. In some embodiments, the secret key 701 may be a symmetric secret key. The secret key 701 may be discarded once it has been used to decrypt the encrypted block of data 707, as it cannot be used to decrypt anther block of data.

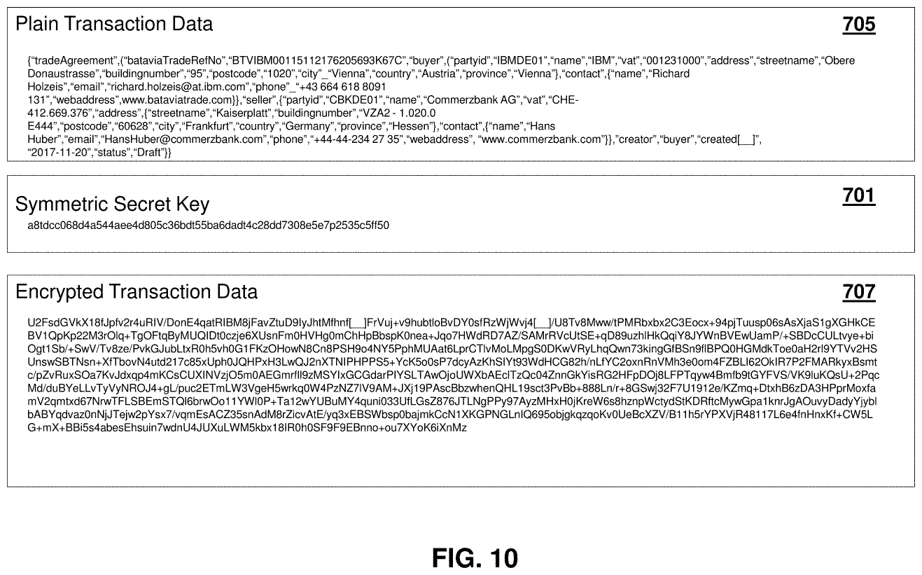

Encryption keys may include alphanumerical values that may be generated at random. FIGS. 10 to 12 illustrate various examples of data encryption according to some embodiments. For example, FIG. 10 shows example plain transaction data elements 705, an example symmetric secret key 701 generated by encryption unit 320, and an example encrypted transaction data 707 encrypted using the secret key 701.

FIG. 11 shows an example private key 708 of a recipient that is kept private by the recipient, an example public key 703 of the recipient that is shared across the network, the public key 703 corresponding to the private key 708, an example symmetric secret key 701 generated by encryption unit 320, and an example encrypted symmetric key 702 encrypted using the recipient's public key 703.

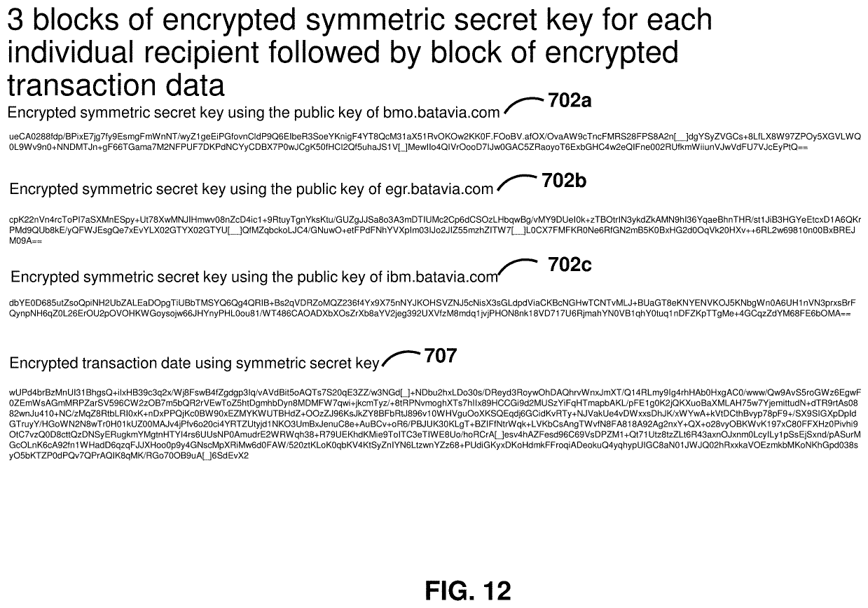

FIG. 12 shows an example block of a blockchain containing encrypted secret keys 702a, 702b, 702c and encrypted data elements 707. The encrypted secret keys 702a, 702b, 702c are each different, since each has been encrypted with a different public key. Each intended recipient can decrypt or “unlock” the secret key 702a, 702b, 702c using its respective private key 708 corresponding to a public key used to encrypt one of encrypted secret keys 702a, 702b, 702c. The encrypted data elements 707 is the same across all recipients, or across the entire distributed blockchain, since it has been encrypted with the secret key 701, and only intended recipients of the data within the block have the means (i.e., the secret key 701 unlocked by the private keys) to decrypt the encrypted data elements 707.

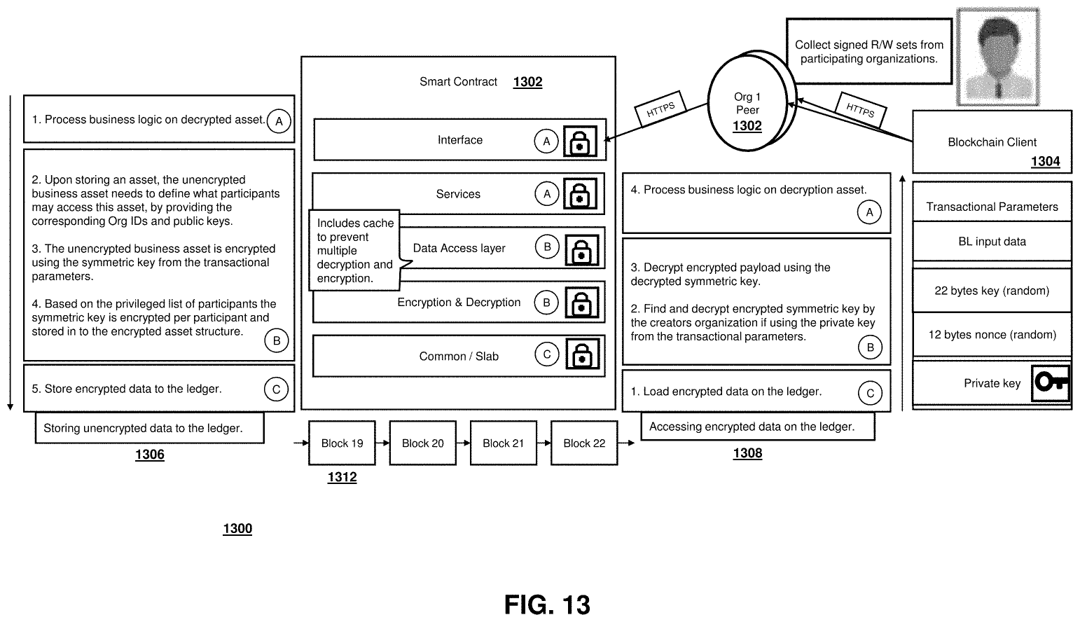

The methods and systems described herein can be applied to encryption and decryption of data corresponding to smart contracts. FIG. 13 is a schematic diagram of an encryption platform 1300 with a smart contract 1302 according to embodiments described herein. The platform 1300 can implement aspects of data encryption described herein according to some embodiments. The smart contract 1302 has an interface, services, data access layer (which includes a cache to prevent multiple or repeat decryption and encryption), encryption and decryption components, and common or stub components. The common or stub components handle the interaction with the blockchain or ledger. The common or stub components integrate with the blockchain to write data to and read data from the blockchain or ledger. The smart contract 1302 can receive requests from an organization or peer 1310 to store unencrypted data to the ledger and access encrypted data on the ledger. The smart contract 1302 can have business logic for implementing a process 1306 for storing unencrypted data to the ledger. The smart contract 1302 can have business logic for implementing a process 1308 for accessing encrypted data on the ledger.

The organization or peer 1310 can receive requests from a blockchain client 1304 to store unencrypted data to the ledger and access encrypted data on the ledger. The blockchain client 1304 can be a middle layer or application programming interface (API) to interact with the blockchain or ledger to manage keys and credentials for a participant. The blockchain client 1304 can have transactional parameters, business logic input data, 32 bytes key (random), 12 bytes nonce (random), and a private key. The transactional parameters can be a header, business logic, input data, terms, and so on. The 32 bytes key is an example secret symmetric key. The client 1304 provides the secret key to the smart contract 1302, and the smart contract 1302 does not generate the secret key. The 12 bytes nonce is an example of the entropy that can be used for the encryption by the smart contract 1302. The 32 bytes key and the 12 bytes nonce can be provided by the blockchain client 1304 to the smart contract 1302 for writing data to the blockchain or ledger. The private key is for accessing data from the blockchain or ledger. The blockchain client 1304 can provide this data to the organization or peer 1310 in association with the requests for provision to the smart contract 1302. The blockchain client 1304 can use HTTPS or another secure connection to keep the credentials secure. The organization or peer 1310 can provide this data to the smart contract 1302 along with the requests. The organization or peer 1310 can collect read/write sets from participating organizations (e.g., organizations associated with blockchain clients 1304). Each participant can be associated with an identifier (e.g., Org ID).

The blockchain client 1304, peer 1310, and smart contract 1302 can connect using HTTPs connections. For example, the blockchain client 1304 requests server (e.g. peer 1310) public key. The blockchain client 1304 validates public key with certificate signing authority. The blockchain client 1304 and server (peer 1310) handshake a cipher process. The blockchain client 1304 generates a symmetric encryption key and encrypts with the server's (peer 1310) public key. This can be repeated with the public key of every node/peer 1310. Server (peer 1310) decrypts symmetric key with private key. This can be repeated by every node/peer 1310 that wants to read the data. The blockchain client 1304 and server (peer 1310) communicate by encrypting/decrypting data with symmetric key. This process can also involve smart contract 1302, for example.

The platform 1300 can also manage public/private key expiry, revocation and renewal. The platform 1300 can also provide asymmetric key management. For example, the platform can implement key management so that if a user is renewing their key pair at the same time a block is being generated this can be flagged and an aspect of the process can be delayed or re-tried, for example. The platform 1300 can also provide notification in the event of key expiration. The platform 1300 can manage public/private key expiry in the event old data is accessed and expired keys are required. There may be constraints around using expired keys. The platform 1300 can assess public/private key strength. The platform 1300 can scale to work with multiple peers 1310, blockchain clients 1304, and smart contracts 1302.

The platform 1300 can implement multi-tenancy so that multiple participants can use a node represented by a peer 1310 for transacting. The peer 1310 or node is a dedicated participant for the encryption and transaction process. An organization might not want to operate their own node or peer 1310 so they can leverage a peer 1310 by providing their participant ID and private key (and transactional parameters along with other data). Accordingly, a peer/node 1310 can relate to multiple participants and those participants can give the peer 1310 their private key to transact on their behalf (and take the key away to stop them in the event they want to use another node or set up their own node).

The smart contract 1302 can implement a process 1306 for storing unencrypted data to the ledger. For example, the smart contract 1302 can use the interface and services to process business logic on a decrypted asset. Upon storing an asset, the smart contract 1302 can use the data access layer to define, for the unencrypted business asset, what participants may access this asset, by providing the corresponding identifiers (e.g. Org IDs) and public keys. The unencrypted business asset is encrypted by smart contract 1302 (e.g. encryption component) using the symmetric key from the transactional parameters from blockchain client 1304. Based on the privileged list of participants the symmetric key is encrypted per participant and stored in to the encrypted asset structure. The smart contract 1302 can use the common or stub component to store the encrypted asset structure on the blockchain or ledger. Example encrypted asset structures stored on the blockchain or ledger are shown as blocks 1312 (e.g. Block 19, Block 20, Block 21, Block 22).

The smart contract 1302 can implement a process 1308 for accessing encrypted data on the ledger. For example, the smart contract 1302 can use the interface and services to process business logic on a decrypted asset. The smart contract 1302 can decrypt encrypted payload using the decrypted symmetric key and the decryption component. The smart contract 1302 can use the data access layer to find and decrypt the encrypted symmetric key by the creator's organization identifier (e.g. Org ID) using the private key from the transactional parameters. The smart contract 1302 can use the common or stub component to load encrypted asset from the ledger or blockchain.

Embodiments described herein can store business logic (e.g., to implement processes described herein) and data on the ledger. To read or access the business logic on the ledger, the platform can implement a process 1308 for accessing encrypted data on the ledger. For the business logic, a new key for writing/encrypting data for the business logic to the blockchain can be generated and used as part of executing business logic. To read or access the business logic, the platform 1300 can use the private key that corresponds to the encrypted business logic. The public key can be distributed/published on the ledger so that peers can access the business logic that can include a map linking keys to organization identifiers.

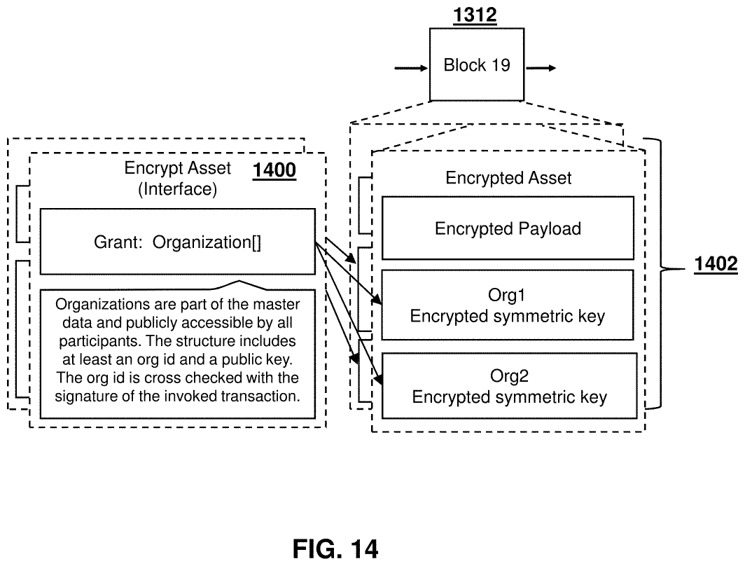

When a processor encrypts data elements using the methods described herein, the processor can store the encrypted data onto a blockchain. FIG. 14 is a schematic diagram of an encrypted asset interface 1400 according to embodiments described herein. The encrypted asset interface 1400 can correspond to the interface of the smart contract 1302, for example, or an aspect of the encryption or decryption component. The encrypted asset interface 1400 can write data to the ledger or blockchain as blocks 1312 of encrypted assets 1402. The encrypted asset interface 1400 can read data from the ledger or blockchain from encrypted assets 1402. An encrypted asset interface 1400 can correspond to an organization or peer 1310.

Accordingly, there can be multiple encrypted asset interfaces 1400 in some examples. An encrypted asset interface 1400 can correspond to multiple organizations or peers 1310 in some examples. Organization data can be part of the master data and publicly accessible by all participants. The structure includes at least an Org ID and a public key, for example. The Org ID can be crosschecked with the signature of the invoked transaction, for example. A public key for an organization can be used to generate an encrypted symmetric key for the organization. The private key for the organization can be used to decrypt the encrypted symmetric key for the organization. The encrypted asset interface 1400 can generate an encrypted asset 1402 (stored as a block 1312). The encrypted asset 1402 can contain encrypted symmetric keys for two example organizations (e.g., Org1, Org2) and an encrypted payload. The encrypted asset 1402 can contain a map that links an organization identifier (e.g., Org1, Org2) to an encrypted symmetric key. The encrypted symmetric key can be encrypted by a public key linked to an organization and decrypted using a private key linked to the organization. The encrypted payload can be encrypted and decrypted using the symmetric key.

FIG. 15 illustrates an example-encrypted asset 1402 that can be stored as a block of a blockchain according to some embodiments. As shown, the encrypted asset 1402 contains encrypted symmetric keys 1500 for two example organizations (e.g., Org1, Org2) and an encrypted payload 1502. The encrypted symmetric keys 1500 are each different, since each has been encrypted with a different public key. Encryption unit 320 can generate the encrypted symmetric keys 1500. Each intended recipient can decrypt or “unlock” its respective symmetric secret key 1500 using its respective private key corresponding to the public key used to encrypt its encrypted secret keys 1500. The encrypted payload 1502 is the same across all recipients (or across the entire distributed blockchain), as it has been encrypted with the secret key, and only intended recipients of the data within the block have the means (i.e., the secret key generated by encrypted symmetric keys 1500 being unlocked by the private keys) to decrypt the encrypted payload 1502.

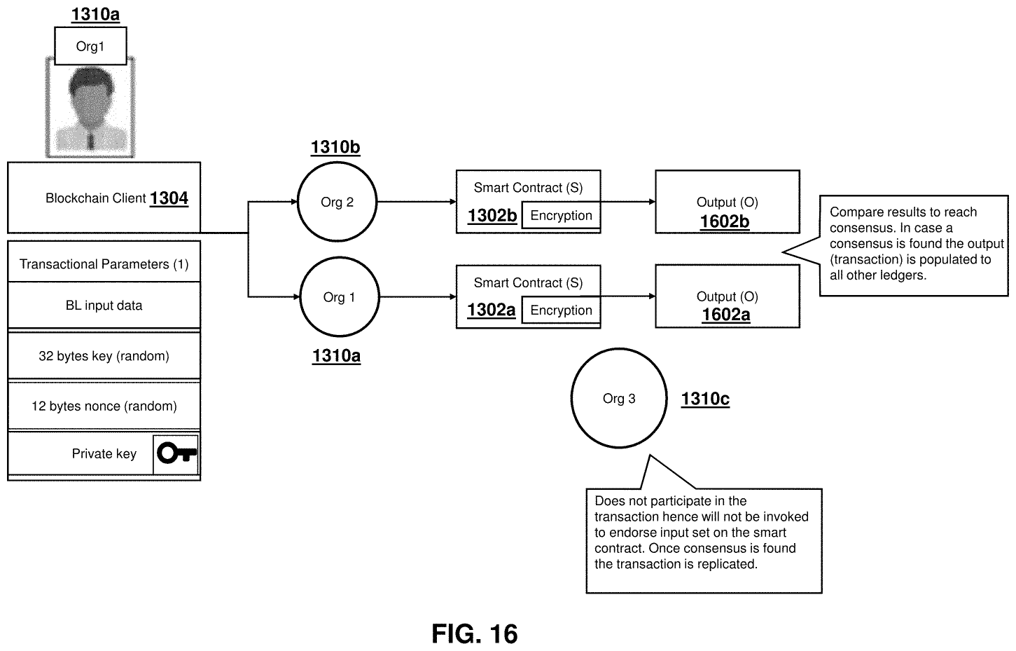

The methods and systems described herein can be implemented on computer platforms that generate smart contract blockchains to efficiently encrypt/decrypt data. FIG. 16 is a schematic diagram of a platform 1600 with a blockchain client 1304 and smart contracts 1302a, 1302b according to embodiments described herein. The blockchain client 1304 can be associated with an organization 1310a or peer. To invoke a transaction, the blockchain client 1304 can provide transaction data input to different organizations 1310a, 1310b or peers that participate in the transaction for endorsement or consensus. The blockchain client 1304 can provide transaction data input for execution by smart contracts 1302a, 1302b to generate output results 1602a, and 1602b. The output results 1602a, 1602b can be compared to reach consensus for the transaction. In case consensus is found, the output (transaction) can be populated to all other blockchains or ledgers. An organization 1310c or peer might not participate in the transaction and so will not be invoked to endorse input set on a smart contract 1302. Once consensus is reached or found the block containing or storing the transaction is replicated. In this example, Org 3 organization 1310c is not participating in the transaction.

The blockchain client 1304 is responsible for collecting endorsements and/or signature data from all peers or organizations 1310a and 1310b required for the transaction (e.g., Org1, Org2) based on an endorsement policy. The endorsement policy can be logic that requires consensus from both Org 1 organization 1310a and Org2 organization 1310b, for example. That is, a consensus in terms of the endorsement policy means that the corresponding endorsements have been collected. Each endorsement produces a read/write set, which can be signed by the corresponding participant (organization), and hence the endorsements can be trusted and the policy can be enforced. The consensus on the next block can be found through an ordering process. The blockchain client 1304 can send the requests for endorsements out in parallel to the smart contracts 1302a and 1302b.

The smart contracts 1302a, 1302b will be invoked with the same input parameters to generate output results 1602a, 1602b. The requests can include the entropy (e.g. 12 bytes nonce), for example. The blockchain client 1304 uses the 12 bytes nonce to extract entropy from the smart contract 1302a and 1302b for encryption. This ensures that the output results 1602a and 1602b can be the same as the same nonce is provided to both smart contracts 1302a and 1302b. A blockchain is an example data structure that enables multiple parties to share data blocks (e.g., a party may want to share private information on a public data infrastructure). A transaction execution needs to be deterministic on several peers, but using encryption there is randomness or entropy that typically does not generate the same cypher text (given the same plain text and encryption algorithm). A token (or nonce) entropy is provided via the transactional input parameters. The token can be used as input to execute the transaction (e.g., token is used as input parameters). The token can be sent to every peer and used for the encryption. Embodiments described herein can use a consistent/deterministic token (considering randomness of encryption process) by extracted entropy used as input for the transaction/encryption process.

The output results 1602a and 1602b can be signed by the peers or organizations 1310a, 1310b to ensure the output results 1602a and 1602b do not change and verify that the output results 1602a and 1602b are from the correct organization 1310a and 1310b. If the output results 1602a, 1602b are not the same then the transaction will be rejected. If the output results 1602a and 1602b are the same then the transaction will be written to the ledger or blockchain.

A transaction can be invoked in parallel on every organization 1310a and 1310b (peer) required for endorsement (e.g. participants in the transaction) as shown in the following:

S(I)->O

where . . .

S . . . smart contract 1302a and 1302b (executed business logic on a peer)

I . . . input set (transactional parameters)

O . . . . Output set 1602a and 1602b (a signed read/write set).

After all transactions are endorsed the output sets 1602a and 1602b are verified against the results all of endorsements. A consensus on the transaction is found if all output sets 1602a and 1602b of the endorsed transaction are equal, or:

∀O of endorsed transactions . . . . O′=O″= . . . .

In order to satisfy the requirement for determination of an output O (1302a and 1302b, on a smart contract S 1302a and 1302b given the same input I, the entropy of encryption has been moved from S to I for all invocations.

Accordingly, embodiments described herein can reach consensus for the transaction based on endorsement by participants to the transaction. The participants to the transaction or a set of peers can be defined by specific business logic for the transaction or an endorsement policy indicates a number of signatures required to make the transaction valid (e.g. two out of all participants in the network—a seller and a buyer—need to agree in order to make the transaction valid). The information regarding the transaction might be secret (e.g., the participants may not want it widely known) to others so embodiments described herein provide a way to have consensus with only a subset of the participants required to endorse the transactions. For example, the buyer and seller can have the private keys for the transaction for the endorsement. There is trust between the buyer and seller parties and that is sufficient for the consensus. In some embodiments, only those participating in the transaction are able to verify the transaction.

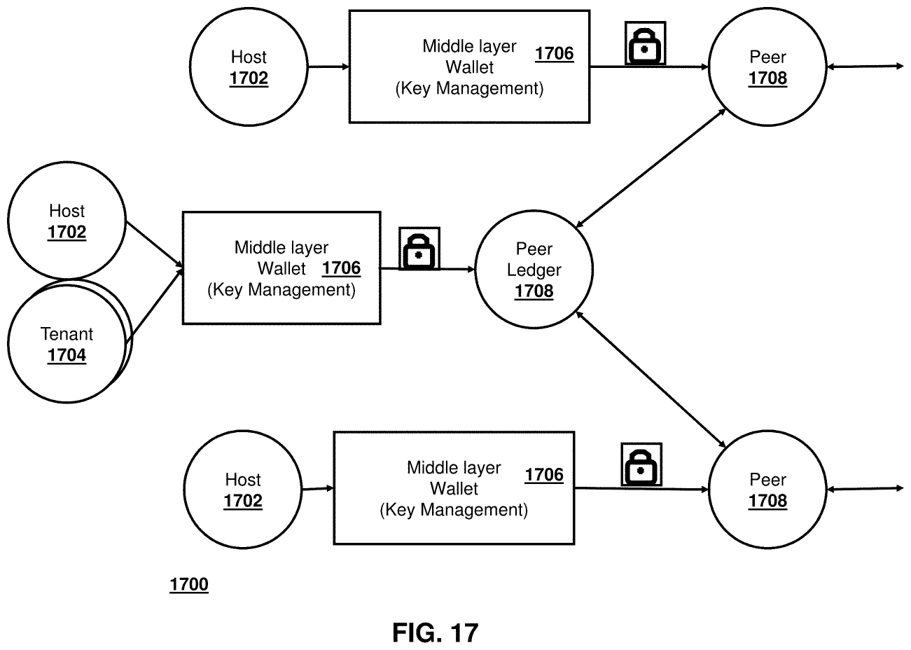

Various computing features can communicate with each other to generate an encrypted blockchain, in accordance with the methods described herein. FIG. 17 is a schematic diagram of an arrangement 1700 of hosts 1702, tenants 1704, and peers 1708 according to some embodiments. Hosts and tenants 1704 are example organizations. A node or peer 1708 is a dedicated participant in the transaction and ledger process. However, not every organization wants to operate their own node or peer 1708 so they can use a node or peer 1708 operated by another entity by providing their participant ID and private key to the node to transact on their behalf. Accordingly, a node or peer 1708 can relate to multiple participants. A participant can take their private key away from a node or peer 1708 to stop the node from transacting on its behalf in the event it wants to use another node or set up their own node. A host 1702 and tenant 1704 can provide input to a middle layer wallet 1706 for middle layer wallet 1706 (key management), which can in turn provide data to a peer ledger 1708 (or peer). The peer ledger 1708 can provide and receive data from other peers 1708.

A host 1702 provides input to a middle layer wallet 1706 for middle layer wallet 1706 (key management), which can in turn provide data to a peer 1708. The middle layer wallet 1706 can implement other functions in addition to key management, such as authentication, authorization and the whole logic for collecting the required endorsements. The middle layer wallet 1706 interacts with peers 1708 and blockchain or ledger. This provides key management in the secure environment so that a participant does not need to store keys on a private device (which may not be secure or tamper proof). There can be different signatures on transactions (endorsements). The hosts 1702 can provide endorsements. The tenant 1704 is a creator of the transaction (not involved in the endorsement). The peer 1708 maintains the ledger/blockchain and the smart contract 1302 using the block chain client 1304, for example.

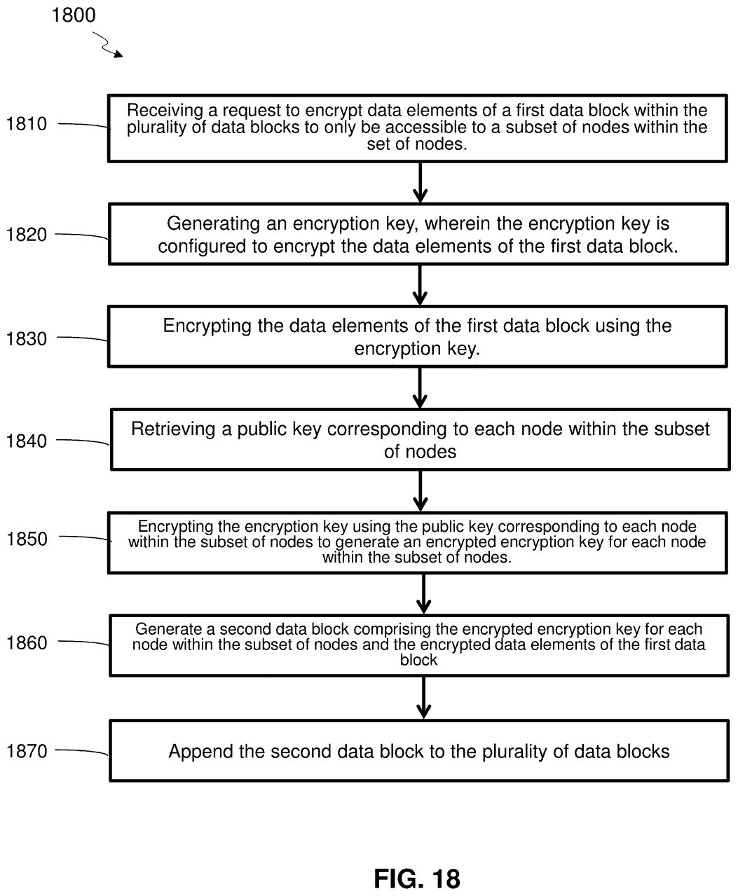

In some embodiments, a processor of a computer associated with a blockchain may encrypt/decrypt blockchain data. FIG. 18 illustrates a schematic diagram of a method for encrypting and decrypting blockchain data, according to an embodiment. FIG. 18 visually illustrates execution of a method 1800 for encrypting and decrypting blockchain data, according to an embodiment. Other embodiments may comprise additional or alternative steps, or may omit some steps altogether. As described herein, the method 1800 may be implemented on any distributed data structure, such as a blockchain distributed among different nodes. The distributed data structure may have a plurality of data blocks where each block comprises data elements accessible to at least one node within the set of nodes. For instance, a blockchain may have multiple data blocks (or blocks) where each block is stored onto a data storage (e.g., local memory or cloud storage) of different nodes.

The steps of the method 1800 can be performed by a central server or central processor. However, in some configurations, one or more steps described in the method 1800 can be performed by different servers and/or processors. For instance, one node associated with the blockchain may perform all or some of the steps of the method 1800. In a non-limiting example, different nodes may perform different steps of the method 1800. Therefore, even though the method 1800 is described herein as being performed by a processor, it does not deviate from the distributed nature of blockchains.

At step 1810, a processor receives a request to encrypt data elements of a first data block within the plurality of data blocks, such that the encrypted data is only accessible to a subset of nodes within the set of nodes. As described herein, a processor may correspond to a processor of any node associated with a blockchain.

The processor may receive a request to encrypt one or more data blocks within a blockchain. For instance, the request may instruct the processor to encrypt the data elements within one or more data blocks, such that the data elements are only accessible to one or more nodes associated with the blockchain. In a non-limiting example, a node (e.g., processor of a computer associated with a blockchain) may transmit an instruction to a processor of a second computer associated with the blockchain to generate a block within an existing blockchain using new data elements. The request may also instruct the processor of the second computer to encrypt the data elements, such that the data elements can only be accessed (e.g., decrypted and/or viewed) by the processor of a third computer and a fourth computer. The request may also include identification of the third and fourth computers (e.g., IP address, MAC address, or an identifying name).

At step 1820, the processor may generate an encryption key, wherein the encryption key is configured to encrypt the data elements of the first data block. The processor may generate an encryption key to encrypt the data elements identified within the request. As described herein, the encryption key is a random string of bits created by the processor explicitly for encrypting/decrypting data (e.g., scrambling/unscrambling data). The processor may generate the encryption key using various algorithms intended to ensure that every key is unpredictable and unique. As will be described below, the processor may encrypt the data using the encryption key and the processor (or any other computer within the node) may use the encryption key to encrypt and decrypt the data element.

At step 1830, the processor may encrypt the data elements of the first data block using the encryption key. The processor may execute one or more encryption protocols to encrypt the data elements identified within the request using the encryption key. The processor may use a variety of encryption methods to encrypt the data element. The processor may use a symmetrical encryption method to encrypt the data element. The symmetrical method ensures that the data elements can be encrypted and then decrypted using the encryption key. Therefore, no other decryption keys may be necessary to decrypt the encrypted data elements. In some embodiments, the processor may use a third-party server or third-party processor to encrypt the data. For instance, the processor may transmit the data element and the encryption key to an encryption server where the encryption server executes one or more encryption protocols and transmits encrypted data back to the processor.

At step 1840, the processor may retrieve a public key corresponding to each node within the subset of nodes. The processor may retrieve a public key associated with each node configured to decrypt (e.g., access or view) the data elements encrypted by the processor. The processor may use the identification of the third computer and the fourth computer (received within the request in step 1810) to retrieve a public key associated with the third and fourth computers. In a non-limiting example, the processor may query a local or third party database to retrieve the public key.

At step 1850, the processor may encrypt the encryption key using the public key corresponding to each node within the subset of nodes to generate an encrypted encryption key for each node within the subset of nodes. Using the public keys retrieved in step 1840, the processor may encrypt the encryption key itself. The processor may execute various asymmetrical encryption protocols to encrypt the encryption key using the public keys retrieved. The processor may encrypt the random string of bits within the encryption key using each public key. As a result, the processor generates as many encrypted encryption keys as public keys. In some configurations, the processor may transmit the encryption key and each public key to an encryption server and receive an encrypted encryption key. For instance, the processor may receive an encrypted encryption key for the third computer and a second encrypted encryption key for the fourth computer.

At step 1860, the processor may generate a second data block comprising the encrypted encryption key for each node within the subset of nodes and the encrypted data elements of the first data block. The processor may generate one or more new blocks and append the new blocks to the existing blockchain. In some configurations, the processor may generate one block that comprises the encrypted encryption key using the first public key, encrypted encryption key using the second public key, and the encrypted data using the encryption key. In some other configurations, the processor may generate a different data block for each encrypted encryption key with each public key. For instance, the processor may generate a data block for the third computer and another data block for the fourth computer. In some embodiments, each block may also include an indication of the nodes (e.g., third and fourth computers).

At step 1870, the processor may append the second data block to the plurality of data blocks within the blockchain. The processor may append the generated data blocks (step 1860) to the blockchain by generating a hash value for the new generated data blocks and appending the newly generated data blocks to the blockchain. The processor may first query all nodes to receive a latest/valid blockchain where each data block is approved by a quorum of nodes before appending the newly generated blocks.

A node that is authorized to access the encrypted data elements within the encrypted data blocks (generated in step 1860) may access the newly generated data blocks by first decrypting the encrypted encryption key using each node's private key. The authorized node may then decrypt the encrypted data element within the newly generated data block using the decrypted encryption key.

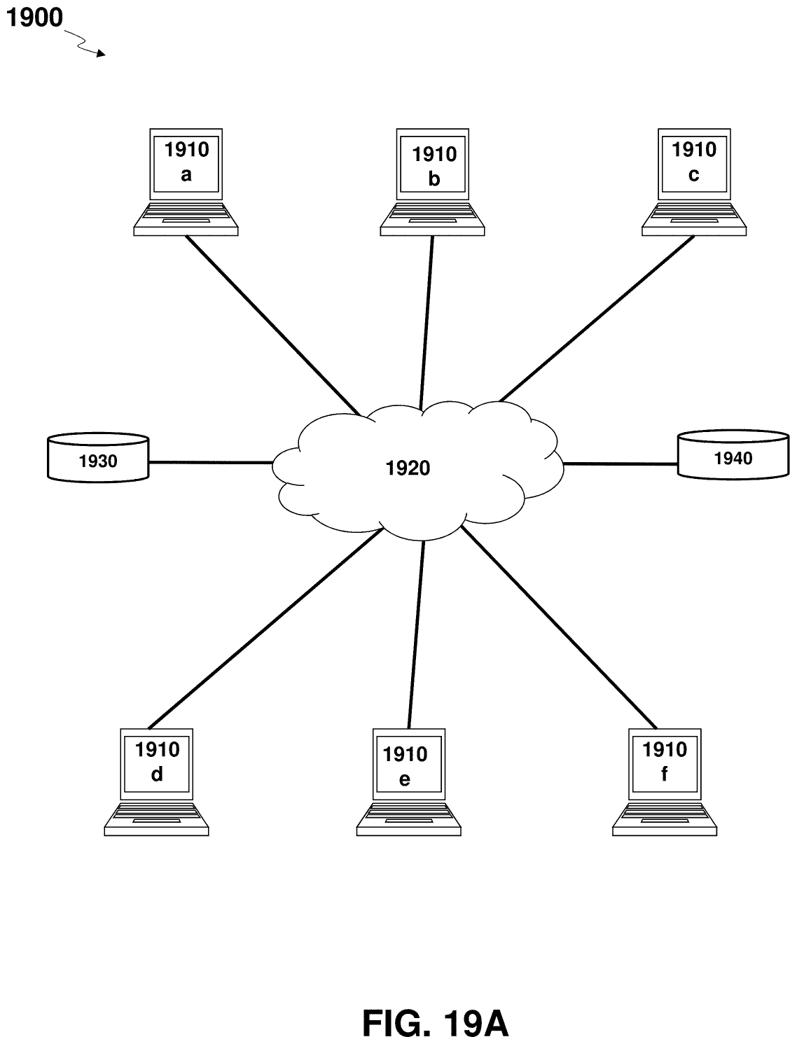

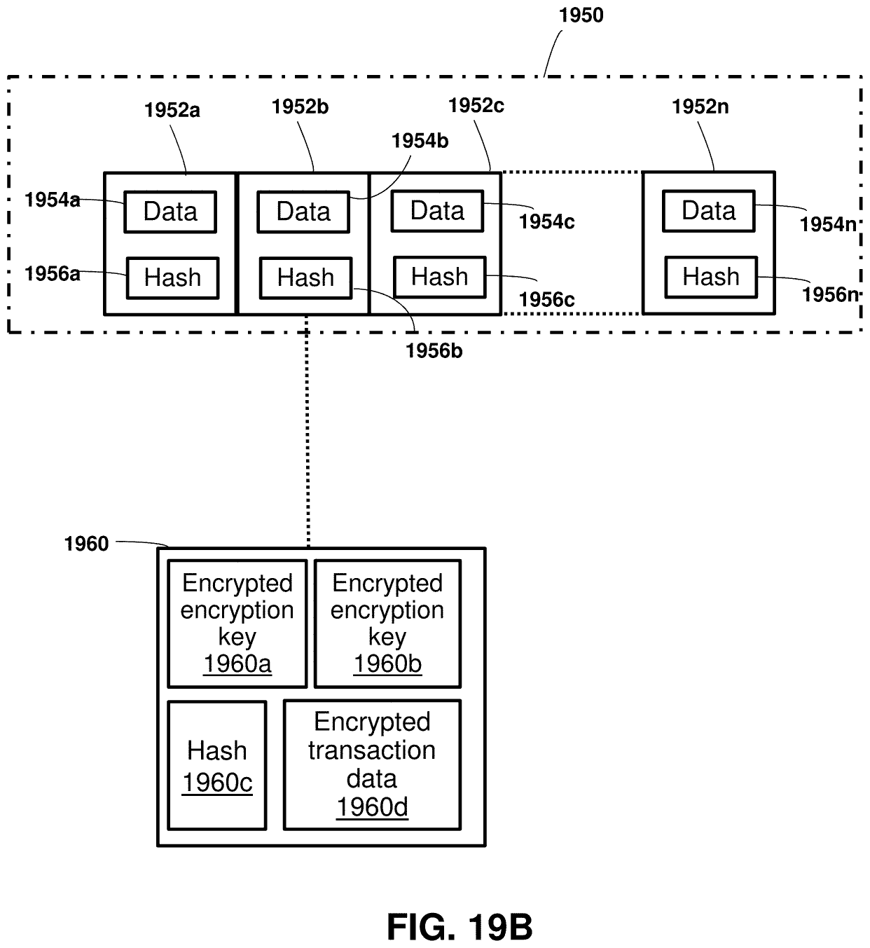

FIGS. 19A-B provide visual presentations of the encryption and decryption methods described herein, according to an embodiment. FIG. 19A illustrates components of a system 1900 for generating and maintaining a blockchain with encrypted data, according to an embodiment. The system 1900 may include nodes 1910a-f (collectively nodes 1910) that are connected to each other via a network 1920. The system 1900 may also include a system database 1930 and a key storage database 1940. Aspects of the system 1900 may be configured to employ and manage a blockchain and may include blockchain-based distributed ledger software (e.g., Hyperledger, Ethereum, Openchain, and TerraLedger).

The blockchain may operate as a distributed database that stores data records associated with users and transaction documents, where the data records stored on the system blockchain may be blocks of data (e.g., block instances or blocks) that are hosted (e.g., locally stored or remotely hosted or hosted in a cloud) on distributed nodes 1910. In some embodiments, the system 1900 may generate a duplicate of one or more blocks within the blockchain and store said blocks in the system database 1930.

The blockchain described in the system 1900 may display a user interface on each node 1910, such as a website. A server associated with the blockchain (e.g., one or more nodes) may host a website accessible to end-users, where the content presented via the various webpages may be controlled based upon each particular user's role. The server may execute software applications configured to display the user interface (e.g., host a website), which may generate and serve various webpages to each node 1910. The website may be used to generate and access data stored on a system database 1930 or the blockchain hosted by nodes 1910.

In some implementations, the website may be configured to require user authentication based upon a set of user authorization credentials (e.g., username, password, biometrics, cryptographic certificate, and the like). In such implementations, the website may access the system database 1930 configured to store user credentials, which the website may be configured to reference in order to determine whether a set of entered credentials (purportedly authenticating the user) match an appropriate set of credentials that identify and authenticate the user. In such implementations, the user's role may be defined by data fields and input fields in user records stored in the system database 1930. The website may authenticate the user and may identify the user's role by executing an access directory protocol (e.g., LDAP). The website may generate webpage content, access or generate data stored in the system database 1930, and access or generate data stored within the blocks, according to the user's role defined by the user record in the system database 1930.

In operation, the nodes 1910 may retrieve user data (e.g., transactions) and may generate and maintain a blockchain using the methods and systems described herein. Machine-readable computer files containing various forms of documents (e.g., PDF, DOC, and XLS) may be uploaded and stored onto various blocks and/or the system database 1930. The system 1900 may also generate a hash value of the document, where the blockchain uses the hash value or other identifier values to reference the file from the system database 1930 and/or the blockchain. The system 1900 may then generate the block address for the file by generating a hash of the document and a hash value of the immediately preceding block data or block address. This block address may then be stored into the system database 1930 in a document record along with the file and any number of additional data field entries related to the computer file.

User records stored on the system database 1930 may comprise a data field containing a user-identifying hash value generated when a new user record is generated or updated onto the blockchain. The hash value (sometimes referred to as the encrypted hash value) may be generated using one or more data fields that describe the user, which may be entered by a user via a website portal or retrieved from the user record in the system database 1930. The hash value may be a unique identifier for the particular user record, and may be used by various computing devices of the system 1900 to reference the user data, which may be stored in the system database 1930 and/or on blocks of the blockchain that is hosted on the nodes 1910. The system database 1930 may be hosted on any number of computing devices comprising a non-transitory machine-readable storage medium and capable of performing the various tasks described herein.

A key storage database 1940, sometimes referred in the art as a high security module, key appliance, certificate authority, or the like, may be a computing device configured to manage and distribute encryption keys and cryptographic certificates to various computing devices in the system 1900 according to predetermined user roles and existing rules. In some implementations, encryption keys may be used for authentication of users when users log into a website (or any other user interface provided to the users) to access the blockchain. In some implementations, encryption keys may be used to encrypt the data within each block of the system blockchain and to prevent unauthorized access. Additionally or alternatively, encryption keys may be used to confirm or “sign” data transfers or to confirm that the data originated from a known party. Encryption keys may also be used by users at an application level to apply a digital signature to a document or contract, which, in some cases, may trigger instructions from script code of a smart contract stored on the system blockchain. The key storage database 1940 may also store a duplicate of each node 1910's public key.

The key storage database 1940 may be hosted on any number of computing devices comprising a non-transitory machine-readable storage medium and capable of performing the various tasks described herein. As shown in FIG. 19A, the key storage database 1940 may be accessed by any node to retrieve or confirm encryption keys or encryption key signatures.

FIG. 19B illustrates a blockchain with customized encrypted data, in accordance with an embodiment. The blockchain 1950 is a visual representation of a blockchain generated and accessible to one or more nodes within the system 1900. Furthermore, the block 1960 is a visual representation of a block encrypted using the methods and systems described herein.

As explained herein, one or more nodes may generate (or instruct a blockchain service to generate) each block within the blockchain 1950, such as the block 1952a. The nodes may receive data 1954a associated with a first node (e.g., node 1910a). Upon generation of block 1952a, the blockchain 1950 may also generate hash value 1956a based on the data 1954a, the first node, identifier information (e.g., time stamp and/or geolocation), and the like. The analytics server may also generate (or instruct a blockchain service to generate) the block 1952b. The analytics server may receive data 1954b from a second node (e.g., node 1910b). The blockchain 1950 may also generate hash value 1956b based on the data 1954b, the second node (e.g., identifier information such as time stamp, geolocation, and/or a computing device identifier), and the like.

The hash value 1956b may also include information regarding the hash value 1956a. The blockchain 1950 may incorporate the hash value 1956a into the hash value 1956b in order to append the block 1952b to the block 1952a. The blockchain 1950 may subsequently poll all the nodes in order to ensure the highest integrity of the blockchain 1950 by appending the latest block to the latest valid blockchain. Using this method, blocks within the blockchain 1950 may be appended to the preceding blocks. The analytics server may generate block 1960 using the same methods explained above in order to continuously update blockchain 1950. As depicted, block 1960 is connected to the blockchain 1950 because of synchronization of hash values 1960c to the blockchain 1950. Modification of data within a block may disconnect that block from the blockchain. The blockchain 1950 may use this method to combat possible fraud or unauthorized modification of the data within a blockchain.

In the depicted non-limiting example, a first node (e.g., node 1910d) receives a request to generate a new block with transaction data. The request also instructs the first node to encrypt the transaction data, such that the transaction data is only accessible to a second and third computer (e.g., node 1910a and 1910b). The request may include an identification of the 1910a and 1910b.

Upon receipt of the request, the first node may first generate and/or retrieve an encryption key. As described herein an encryption key may represent any machine-readable and/or executable code (e.g., generated bits) that are configured to encrypt data. The first node may retrieve the encryption key from the system database 1930 and/or the key storage database 1940. For instance, each time that the first node is instructed to encrypt data, the first node may query and receive an encryption key form the system database 1930. In this way, the encryption key may be chosen at random in order to provide additional security for sensitive data, such as the transaction data. Moreover, the first node may use different encryption keys for each encryption request.

In some configurations, the first node may generate a unique encryption key for each request. For instance, the first node may execute a protocol that generates a unique encryption key for the request received. The encryption key may be any key configured to provide symmetrical encryption. That is, the first node (or another other node within the blockchain 1950) may encrypt and decrypt data using the same encryption key.

Upon retrieving/generating the encryption key, the first node may execute an encryption protocol using the encryption key to encrypt the transaction data received. As a result, the first node may generate the encrypted transaction data 1960d. The first node may then retrieve a public key associated with the second and third nodes from the key storage database 1940.

As described above, the request received by the first node comprises an identification of one or more nodes that are authorized to access the encrypted transaction data. The first node may use the identification to query an internal (e.g., key storage database 1940) or an external/third party database to receive public keys associated with the second and third nodes. Upon receiving the public key, the first node may execute an asymmetrical encryption protocol to encrypt the encryption key itself. As a result, the first node may generate two encrypted encryption keys because the first node generates the encrypted encryption key 1960a using the second node's (node 1910a) public key and the encrypted encryption key 1960b using the third node's (node 1910b) public key. The asymmetrical encryption method ensures that the encrypted data can only be decrypted using a corresponding private key.

The first node may then generate a new block 1960 that includes the encrypted transaction data 1960d and the encrypted encryption keys 1960a-b. The first node may then generate a hash value 1960c for the block 1960 in order to append the block 1960 to the blockchain 1950. In some configurations, the processor may generate a separate block for each node that is authorized to access the encrypted data. For instance, the first node may generate a first data block for node 1910a that includes the encrypted encryption key 1960a, hash 1960c, and the encrypted transaction data 1960d. The first node may then generate a second block for node 1910b that includes the encrypted encryption key 1960b, hash 1960c, and the encrypted transaction data 1960d.

In order to decrypt the encrypted transaction data 1960d, an authorized node (node 1910a and/or 1910b) may first use its private key to decrypt the encrypted encryption key. For instance, when the second node desires to access the transaction data encrypted within the block 1960, the second node may first access block 1960. The second node may then use an asymmetrical decryption method to decrypt the encrypted encryption key 1960a using its private key. Once decrypted, the second node may then execute a symmetrical decryption method to decrypt the encrypted transaction data 1960d using the encryption key that is now decrypted.

In one example, a blockchain is configured to store data transmitted among multiple computers. The ledger is publicly accessible; however, the blockchain must be stored, such that the actual data transmitted can only be accessed by the participants of the data transmittal. For instance, if a first node transmits a message to a second node, the blockchain will reveal that a message was transmitted from the first node to the second node. However, the blockchain must be maintained, such that only the first node and the second node may view the content of the message.

In order to encrypt data and maintain the blockchain described above, when the first node transmits a message to the second node, a processor of the second node (or any other node associated with the blockchain) first generates an encryption key by executing an algorithm that generates encryption keys that include randomly selected alphanumerical values. The processor then executes a symmetrical encryption algorithm to encrypt the content of the message. The processor may then retrieve a public key associated with the first node and the second node. The processor then executes an asymmetrical encryption method to encrypt the content of the encryption key itself. As a result, the processor generates a first encrypted encryption key using the first node's public key and a second encrypted encryption key using the second node's public key. The processor then generates two new blocks: a first block that includes the first encrypted encryption key and the encrypted message and a second block that includes the second encrypted encryption key and the encrypted message. The processor then appends both blocks to the blockchain.

When a processor of the first node is instructed to display the content of the message, the processor first retrieves a public key for the first node and executes an asymmetrical decryption method to decrypt the encrypted encryption key within the first block. The processor then uses the decrypted encryption key and executes a symmetrical decryption protocol to decrypt the encrypted message. Upon decrypting the message, the processor can have access to the message and display the message.

The embodiments of the devices, systems and processes described herein may be implemented in a combination of both hardware and software. These embodiments may be implemented on programmable computers, each computer including at least one processor, a data storage system (including volatile memory or non-volatile memory or other data storage elements or a combination thereof), and at least one communication interface.

Program code is applied to input data to perform the functions described herein and to generate output information. The output information is applied to one or more output devices. In some embodiments, the communication interface may be a network communication interface. In embodiments in which elements may be combined, the communication interface may be a software communication interface, such as those for inter-process communication. In still other embodiments, there may be a combination of communication interfaces implemented as hardware, software, or combinations thereof.

Throughout the foregoing discussion, numerous references may be made regarding control and computing devices. It should be appreciated that the use of such terms may represent one or more computing devices having at least one processor configured to execute software instructions stored on a computer readable tangible, non-transitory medium. For example, the platform 300 may have a server that includes one or more computers coupled to a web server, database server, or other type of computer server in a manner to fulfill described roles, responsibilities, or functions.

The foregoing discussion provides many example embodiments. Although each embodiment represents a single combination of inventive elements, other examples may include all possible combinations of the disclosed elements. Thus if one embodiment comprises elements A, B, and C, and a second embodiment comprises elements B and D, other remaining combinations of A, B, C, or D, may also be used.

The term “connected” or “coupled to” may include both direct coupling (in which two elements that are coupled to each other contact each other) and indirect coupling (in which at least one additional element is located between the two elements).

The technical solution of embodiments may be in the form of a software product instructing physical operations. The software product may be stored in a non-volatile or non-transitory storage medium, which can be a compact disk read-only memory (CD-ROM), a USB flash disk, or a removable hard disk. The software product includes a number of instructions that enable a computer device (personal computer, server, or network device) to execute the processes provided by the embodiments.

The embodiments described herein are implemented by physical computer hardware, including computing devices, servers, receivers, transmitters, processors, memory, displays, and networks. The embodiments described herein provide useful physical machines and particularly configured computer hardware arrangements. The embodiments described herein are directed to electronic machines and processes implemented by electronic machines adapted for processing and transforming electromagnetic signals, which represent various types of information. The embodiments described herein pervasively and integrally relate to machines, and their uses; and the embodiments described herein have no meaning or practical applicability outside their use with computer hardware, machines, and various hardware components. Substituting the physical hardware particularly configured to implement various acts for non-physical hardware, using mental steps for example, may substantially affect the way the embodiments work. Such computer hardware limitations are clearly essential elements of the embodiments described herein, and they cannot be omitted or substituted for mental means without having a material effect on the operation and structure of the embodiments described herein. The computer hardware is essential to implement the various embodiments described herein and is not merely used to perform steps expeditiously and in an efficient manner.

The platform 300 may be implemented as a computing device with at least one processor, a data storage device (including volatile memory or non-volatile memory or other data storage elements or a combination thereof), and at least one communication interface. The computing device components may be connected in various ways including directly coupled, indirectly coupled via a network, and distributed over a wide geographic area and connected via a network (which may be referred to as “cloud computing”).

For example, and without limitation, the computing device may be a server, network appliance, microelectromechanical Systems (MEMS) or micro-size mechanical devices, set-top box, embedded device, computer expansion module, personal computer, laptop, personal data assistant, cellular telephone, smartphone device, UMPC tablets, video display terminal, gaming console, electronic reading device, and wireless hypermedia device or any other computing device capable of being configured to carry out the processes described herein.

A processor may be, for example, a general-purpose microprocessor or microcontroller, a digital signal processing (DSP) processor, an integrated circuit, a field programmable gate array (FPGA), a reconfigurable processor, a programmable read-only memory (PROM), or any combination thereof.

Data storage device may include a suitable combination of any type of computer memory that is located either internally or externally such as, for example, random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), Ferroelectric RAM (FRAM) or the like.

Computing device may include an I/O interface to enable computing device to interconnect with one or more input devices, such as a keyboard, mouse, camera, touch screen and a microphone, or with one or more output devices such as a display screen and a speaker.

Although the embodiments have been described in detail, it should be understood that various changes, substitutions and alterations could be made herein without departing from the scope as defined by the appended claims.

Moreover, the scope of the present application is not intended to be limited to the particular embodiments of the process, machine, manufacture, composition of matter, means, processes and steps described in the specification. As one of ordinary skill in the art will readily appreciate from the disclosure of the present invention, processes, machines, manufacture, compositions of matter, means, processes, or steps, presently existing or later to be developed, that perform substantially the same function or achieve substantially the same result as the corresponding embodiments described herein may be utilized. Accordingly, the appended claims are intended to include within their scope such processes, machines, manufacture, compositions of matter, means, processes, or steps.

As can be understood, the examples described above and illustrated are intended to be exemplary only. The scope is indicated by the appended claims.

What we claim is:

1. A computer system comprising:
a data structure distributed among a set of nodes, the data structure having a plurality of data blocks, each block comprising data elements accessible to at least one node within the set of nodes;
a processor in communication with at least one node, wherein when the processor receives a request to encrypt data elements of a first data block within the plurality of data blocks to only be accessible to a subset of nodes within the set of nodes, the processor is configured to:
generate an encryption key, wherein the encryption key is configured to encrypt the data elements of the first data block;
encrypt the data elements of the first data block using the encryption key;
retrieve a public key corresponding to each node within the subset of nodes;
encrypt the encryption key using the public key corresponding to each node within the subset of nodes, wherein the processor generates an encrypted encryption key for each node within the subset of nodes;
generate a second data block comprising the encrypted encryption key for each node within the subset of nodes and the encrypted data elements of the first data block; and
append the second data block to the plurality of data blocks.

2. The computer system of claim 1, wherein the processor is configured to use a symmetrical encryption protocol to encrypt the data elements of the first data block using the encryption key.

3. The computer system of claim 1, wherein the processor is configured to use an asymmetrical encryption protocol to encrypt the encryption key.

4. The computer system of claim 1, wherein the data elements correspond to transaction data.

5. The computer system of claim 4, wherein the processor is configured to:
prior to appending the second data block to the plurality of data blocks, identify participants to the transaction data, receive output results from the participants in the transaction data and determine that the output results from the participants are the same.

6. The computer system of claim 5, wherein the processor is configured to provide a nonce as an input parameter to each of the participants for generating the output results.

7. The computer system of claim 1, wherein the processor is configured to generate a second data block for each node within the subset of nodes, wherein each second data block comprises the encrypted encryption key for each respective node and the encrypted data elements of the first data block.

8. The computer system of claim 1, wherein the processor is configured to generate the second data block to comprise a map that links an organization identifier to the encrypted encryption key.

9. A method comprising:
upon receiving a request to encrypt data elements of a first data block of a plurality of data blocks to only be accessible to a subset of nodes within a set of nodes associated with a blockchain:
generating, by a processor of at least one node, an encryption key, wherein the encryption key is configured to encrypt the data elements of the first data block;
encrypting, by the processor, the data elements of the first data block using the encryption key;
retrieving, by the processor, a public key corresponding to each node within the subset of nodes;
encrypting, by the processor, the encryption key using the public key corresponding to each node within the subset of nodes, wherein the processor generates to generate an encrypted encryption key for each node within the subset of nodes;
generating, by the processor, a second data block comprising the encrypted encryption key for each node within the subset of nodes and the encrypted data elements of the first data block; and
appending, by the processor, the second data block to the plurality of data blocks.

10. The method of claim 9, wherein the processor uses a symmetrical encryption protocol to encrypt the data elements of the first data block using the encryption key.

11. The method of claim 9, wherein the processor uses an asymmetrical encryption protocol to encrypt the encryption key.

12. The method of claim 9, wherein the data elements correspond to transaction data.

13. The method of claim 12, further comprising:
prior to appending the second data block to the plurality of data blocks, identifying, by the processor, participants to the transaction data, receive output results from the participants in the transaction data and determine that the output results from the participants are the same.

14. The method of claim 13, wherein the processor provides a nonce as an input parameter to each of the participants for generating the output results.

15. The method of claim 9, wherein the processor generates a second data block for each node within the subset of nodes, wherein each second data block comprises the encrypted encryption key for each respective node and the encrypted data elements of the first data block.

16. The method of claim 9, wherein the processor generates the second data block to comprise a map that links an organization identifier to the encrypted encryption key.

17. A data structure distributed among a set of nodes, the data structure comprising:
a plurality of data blocks, each block comprising data elements hosted on and accessible to at least one node within the set of nodes, wherein a processor in communication with at least one node is configured to:
in response to receiving a request to encrypt data elements of a first data block within the plurality of data blocks to only be accessible to a subset of nodes within the set of nodes, generate an encryption key, wherein the encryption key is configured to encrypt the data elements of the first data block;
encrypt the data elements of the first data block using the encryption key;
retrieve a public key corresponding to each node within the subset of nodes;
encrypt the encryption key using the public key corresponding to each node within the subset of nodes, wherein the processor generates to generate an encrypted encryption key for each node within the subset of nodes;
generate a second data block comprising the encrypted encryption key for each node within the subset of nodes and the encrypted data elements of the first data block; and
append the second data block to the plurality of data blocks.

18. The data structure of claim 17, wherein the processor is configured to use a symmetrical encryption protocol to encrypt the data elements of the first data block using the encryption key.

19. The data structure of claim 17, wherein the processor is configured to use an a-symmetrical encryption protocol to encrypt the encryption key.

20. The data structure of claim 17, wherein the data elements correspond to transaction data.
